(19) United States
(12) Patent Application Publication
(10) Pub. No.: US 2024/0077794 A1
(43) Pub. Date: Mar. 7, 2024

(54) PROJECTION OPTICAL SYSTEM AND PROJECTION TYPE DISPLAY APPARATUS

(71) Applicant: FUJIFILM Corporation, Tokyo (JP)

(72) Inventors: Yukiko NAGATOSHI, Saitama (JP); Taku FURUBAYASHI, Saitama (JP)

(73) Assignee: FUJIFILM Corporation, Tokyo (JP)

(21) Appl. No.: 18/454,547

(22) Filed: Aug. 23, 2023

(30) Foreign Application Priority Data
Aug. 30, 2022 (JP) 2022-137266

(51) Int. Cl. G03B 21/14; G02B 13/16

(52) U.S. Cl. CPC G03B 21/142; G02B 13/16

(57) ABSTRACT

The projection optical system that projects an image, which is displayed on an image display surface on a reduction side, to a magnification side, in which at least one intermediate image is formed inside the projection optical system, and the projection optical system includes a first stop, of which an aperture diameter is variable, at a position closer to the reduction side than the intermediate image closest to the reduction side.

### CROSS-REFERENCE TO RELATED APPLICATIONS

This application claims priority from Japanese Patent Application No. 2022-137266, filed on Aug. 30, 2022, the entire disclosure of which is incorporated herein by reference.

### BACKGROUND OF THE INVENTION

### Technical Field

The technique of the present disclosure relates to a projection optical system and a projection type display apparatus.

### Related Art

Japanese Patent No. 2981497 describes a retro-focus type lens that can be used in a projection type display apparatus.

### SUMMARY

In recent years, a projection optical system including a relay optical system and forming an intermediate image has been increasing. The relay optical system is disposed closer to the reduction side than the intermediate image to relay the image. The type of projection optical system has an advantage in that a long back focal length required in a projection type display apparatus can be ensured, and has an advantage in that an increase in diameter of the lens can be suppressed even with an ultra-wide-angle lens. Further, in the type of projection optical system, there is an advantage in that an imaging lens, of which either a back focal length or a pupil condition of the optical system is not suitable for a projector engine, can be used as an interchangeable lens.

Meanwhile, in the projection type display apparatus, it is desired to adjust the luminance and the contrast ratio. In order to meet the demand, it is conceivable to provide a stop of which an aperture diameter is variable. However, disposing such a stop at a position closer to the magnification side than the intermediate image is not effective in improving the contrast ratio.

The present disclosure has been made in view of the above-mentioned circumstances, and it is an object to provide, in a projection optical system of a type that forms an intermediate image, a projection optical system capable of satisfactorily adjusting a luminance and a contrast ratio, and a projection type display apparatus comprising the projection optical system.

According to an aspect of the present disclosure, there is provided a projection optical system that projects an image, which is displayed on an image display surface on a reduction side, to a magnification side. At least one intermediate image is formed inside the projection optical system, and the projection optical system comprises a first stop, of which an aperture diameter is variable, at a position closer to the reduction side than the intermediate image closest to the reduction side.

In the above-mentioned aspect, it is preferable that the projection optical system further comprises an interchangeable optical system at a position closer to the magnification side than the first stop. In such a case, it is preferable that the interchangeable optical system includes a second stop of which an aperture diameter is variable, and an F number of the projection optical system is determined by the first stop. Further, it is preferable that the projection optical system comprises a group that moves by changing a spacing between adjacent groups during magnification change, in a part different from the interchangeable optical system.

Further, assuming that a combined lateral magnification of lenses ranging from a lens closest to the magnification side among lenses, of which magnification side lens surfaces are located closer to the reduction side than the intermediate image closest to the reduction side, to a lens closest to the reduction side in the projection optical system is β. Here, β is a value in a case where the magnification side is an object side and the reduction side is an image side, and β is a value at a wide angle end in a case where the projection optical system includes a variable magnification optical system, it is preferable that the projection optical system satisfies Conditional Expression (1), and it is more preferable that the projection optical system satisfies Conditional Expression (1-1).
0.25<|β|<2 (1)
0.4<|β|<1.5 (1-1)

In the above-mentioned aspect, stop blades included in the first stop may be configured to be made of metal. Alternatively, stop blades included in the first stop may be configured to be made of heat resistant resin.

According to another aspect of the present disclosure, there is provided a projection type display apparatus comprising a light valve that outputs an image and the projection optical system according to the above-mentioned aspect.

In the present specification, it should be noted that the term “consists of” means that the lens may include not only the above-mentioned components but also lenses substantially having no powers, optical elements, which are not lenses, such as a stop, a mask, a filter, a cover glass, a plane mirror, and a prism, and mechanism parts such as a lens flange, a lens barrel, an imaging element, and a camera shaking correction mechanism. Further, the “lens group” may include optical elements other than the lens such as a stop, a mask, a filter, a cover glass, a plane mirror, and a prism in addition to the lens. The term “lens group” is not limited to a configuration consisting of a plurality of lenses, but may consist of only one lens.

The “d line”, “C line”, and “F line” described in the present specification are bright lines, the wavelength of the d line is 587.56 nm (nanometers), the wavelength of the C line is 656.27 nm (nanometers), and the wavelength of the F line is 486.13 nm (nanometers).

According to the present disclosure, it is possible to provide a projection optical system capable of satisfactorily adjusting a luminance and a contrast ratio in a projection optical system of a type forming an intermediate image, and a projection type display apparatus comprising the projection optical system.

### BRIEF DESCRIPTION OF THE DRAWINGS

FIG. 1 is a cross-sectional view showing a configuration and luminous flux of a projection optical system of Example 1.

FIG. 2 is a diagram showing an example of a stop of which an aperture diameter is variable.

FIG. 3 is a cross-sectional view showing a configuration and luminous flux of a projection optical system of Example 2.

FIG. 4 is a cross-sectional view showing a configuration and luminous flux of a projection optical system of Example 3.

FIG. 5 is a cross-sectional view showing a configuration and luminous flux of a projection optical system of Example 4.

FIG. 6 is a cross-sectional view showing a configuration and luminous flux of a projection optical system of Example 5.

FIG. 7 is a cross-sectional view showing a configuration and luminous flux of a projection optical system according to a modification example of Example 5.

FIG. 8 is a cross-sectional view showing a configuration and luminous flux of a projection optical system of Example 6.

FIG. 9 is a cross-sectional view showing a configuration and luminous flux of a projection optical system of Example 7.

FIG. 10 is a cross-sectional view showing a configuration and luminous flux of a projection optical system of Example 8.

FIG. 11 is a schematic configuration diagram of a projection type display apparatus according to an embodiment.

FIG. 12 is a schematic configuration diagram of a projection type display apparatus according to another embodiment.

FIG. 13 is a schematic configuration diagram of a projection type display apparatus according to still another embodiment.

### DESCRIPTION OF EMBODIMENTS

Hereinafter, embodiments of the present disclosure will be described with reference to the accompanying drawings.

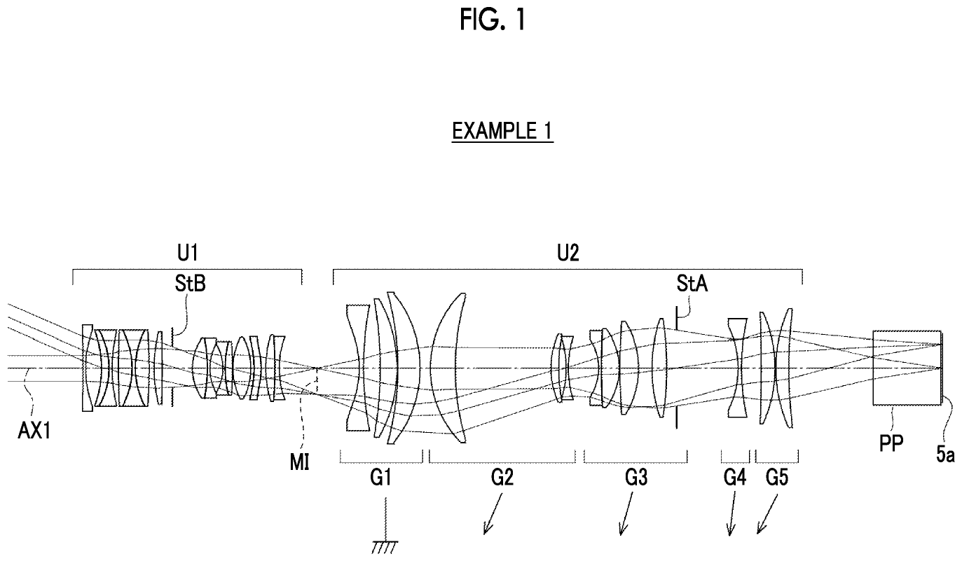

FIG. 1 shows a configuration of a projection optical system and a cross-sectional view of luminous flux according to an embodiment of the present disclosure. FIG. 1 shows, as the luminous flux, on-axis luminous flux and luminous flux with the maximum angle of view. The example shown in FIG. 1 corresponds to a projection optical system of Example 1 to be described later. In FIG. 1, the left side is the magnification side, and the right side is the reduction side.

FIG. 1 shows an example in which an optical member PP and an image display surface 5a of a light valve are disposed on the reduction side of the projection optical system on the assumption that the projection optical system is mounted on the projection type display apparatus. The optical member PP is a member which is regarded as a filter, a cover glass, a color synthesis prism, or the like. The optical member PP is a member that does not have power (refractive power), and a configuration in which the optical member PP is removed may be used. As the light valve, for example, a liquid crystal display element or an image display element such as digital micromirror device (DMD: registered trademark) can be used. The light valve outputs an optical image, and the optical image is displayed as an image on the image display surface 5a.

The projection optical system is, for example, mounted on a projection type display apparatus and projects an image displayed on the image display surface 5a on the reduction side to the magnification side. In the projection type display apparatus, luminous flux provided with image information on the image display surface 5a is incident on the projection optical system and is projected onto a screen, which is not shown, on the magnification side through the projection optical system. An image, which is displayed on the image display surface 5a, and a projected image, which is formed on the screen by the projection optical system, are optically conjugated. It should be noted that, in the present specification, the term “screen” means an object on which a projected image formed by the projection optical system is projected. The screen may be not only a dedicated screen but also a wall surface of a room, a floor surface, a ceiling surface, an outer wall surface of a building, or the like.

Further, in the present specification, the term “magnification side” means the screen side on the optical path, and the “reduction side” means the image display surface 5a side on the optical path. In the present specification, the terms “magnification side” and “reduction side” are determined along the optical path, and this point is the same in a case of the optical system forming the deflected optical path. In the following description, in order to avoid making the description redundant, the phrase “in order from the magnification side to the reduction side along the optical path” may be described as “in order from the magnification side to the reduction side”.

The projection optical system of the present disclosure includes a relay optical system, and at least one intermediate image MI is formed in the projection optical system. In the present disclosure, an optical system that is disposed at a position closer to the reduction side than the intermediate image MI and relays the image is referred to as a “relay optical system”. In FIG. 1, the intermediate image MI is simply indicated by a dotted line. The intermediate image MI in FIG. 1 indicates a position and does not necessarily indicate an accurate shape.

For example, the projection optical system of FIG. 1 consists of the first optical system U1 and the second optical system U2, in order from the magnification side to the reduction side along the optical axis AX1. The second optical system U2 corresponds to the relay optical system, and the intermediate image MI is formed between the first optical system U1 and the second optical system U2. Such an optical system that forms the intermediate image MI has the following advantage. It is possible to reduce a lens diameter on the magnification side of the first optical system U1 while ensuring a back focal length that has a length sufficient to dispose the optical member PP on the reduction side in the second optical system U2.

The projection optical system of the present disclosure includes a stop StA of which an aperture diameter is variable at a position closer to the reduction side than the intermediate image MI closest to the reduction side. Hereinafter, the stop, of which the aperture diameter is variable, will be referred to as a “variable stop”. In the example of FIG. 1, the second optical system U2, which is a relay optical system, includes the stop StA which is a variable stop. The stop StA corresponds to the “first stop” of the technique of the present disclosure. By changing the aperture diameter of the stop StA, the luminance and the contrast ratio can be adjusted. For improvement in the contrast ratio, it is effective to block rays on a side close to the light source in order to suppress undesirable rays from reaching the lens surface, the component frame, or the like as much as possible. Therefore, in the present disclosure, as shown in FIG. 1, the stop StA is disposed inside the second optical system U2 instead of the first optical system U1.

Further, in an optical system of a type that forms the intermediate image MI, it is also possible to obtain an advantage due to the following circumstances by providing the variable stop closer to the reduction side than the intermediate image MI. In a case where the amount of light is adjusted using the variable stop, it is desirable that the luminance of the entire projected image is uniform. In particular, it is desirable that the ambient light amount ratio in the projected image is as uniform as possible in a state where the variable stop is stopped down. In general, in an optical system of a type that forms the intermediate image MI, the pupil aberration is satisfactorily corrected at the pupil position of the relay optical system. Therefore, this configuration is suitable for making an ambient light amount ratio uniform in a state where the variable stop is disposed in the relay optical system and the variable stop in the relay optical system is stopped down. On the other hand, the pupil aberration is mostly large at the pupil position closer to the magnification side than the intermediate image MI. Therefore, even in a case where the variable stop is disposed closer to the magnification side than the intermediate image MI and only the variable stop blocks rays, it is difficult to keep the ambient light amount ratio constant in a state where the variable stop disposed closer to the magnification side than the intermediate image MI is stopped.

It is preferable that the projection optical system of the present disclosure includes an interchangeable optical system closer to the magnification side than the stop StA. According to this configuration, in a case of coping with various states, it is possible to replace only a part of the projection optical system and share the other parts with each other, instead of replacing the whole part. In particular, by sharing a portion including the stop StA that is connected to the drive portion that changes the aperture diameter thereof, it is possible to simplify the structure of the portion to be replaced.

For example, in the example of FIG. 1, a general commercially available lens such as an interchangeable lens for a digital camera may be used as the first optical system U1, and the first optical system U1 may be an interchangeable optical system. Commercially available lenses as described above have various specifications, are inexpensive, and have advantages of favorable availability.

In a case where the projection optical system includes an interchangeable optical system on the magnification side of the stop StA, it is preferable that lens barrels different from each other house the interchangeable optical system and the other optical system in the projection optical system. In such a case, only the interchangeable optical system can be easily replaced while the other optical system remains stationary. In the example of FIG. 1, the different lens barrels (not shown in the drawing) may house the first optical system U1 and the second optical system U2. For example, in a case where the first optical system U1 includes a lens, the lens frame is provided inside the lens barrel for the first optical system U1, and each lens or each lens group of the first optical system U1 is disposed in the lens frame. In a case where a plurality of lenses or lens groups of the first optical system U1 are present, a plurality of lens frames are also present for the number of lenses or lens groups. The lens barrel for the first optical system U1 collectively houses the lens frames and holds the entire first optical system U1. In a similar manner, for the second optical system U2, the lens barrel for the second optical system U2 collectively houses the lens frame and holds the entire second optical system U2. The lens barrel for the first optical system U1 and the lens barrel for the second optical system U2 are separate members different from each other. Each of the lens barrel for the first optical system U1 and the lens barrel for the second optical system U2 is a member which houses individual optical systems. It is also possible to remove each lens frame by configuring the lens barrel for the first optical system U1 and the lens barrel for the second optical system U2 to directly hold each lens or each lens group.

The interchangeable optical system may include a stop StB of which an aperture diameter is variable. In a case where the interchangeable optical system includes a stop StB, it is preferable that the F number of the projection optical system is determined by the stop StA. The stop StB corresponds to a “second stop” of the technique of the present disclosure. In the most projection type display apparatuses, the intensity of the projection light is increased or a high-intensity light source is used such that a clear projected image can be obtained even in an environment where there is external light or bright illumination light. The general commercially available lens has an internal stop, but the stop usually does not ensure heat resistance such that there is no problem even in a case where the projection type display apparatus is exposed to strong light. Therefore, a problem may occur in a case where the projection type display apparatus is not exposed to the strong light. Therefore, heat resistance of the stop StA is ensured such that there is no problem even in a case where the projection type display apparatus is exposed to strong light, and the stop StA blocks rays such that the F number is determined by the stop StA instead of the stop StB. In such a case, the above-mentioned problems can be avoided, and the general commercially available lens can be used as an interchangeable optical system.

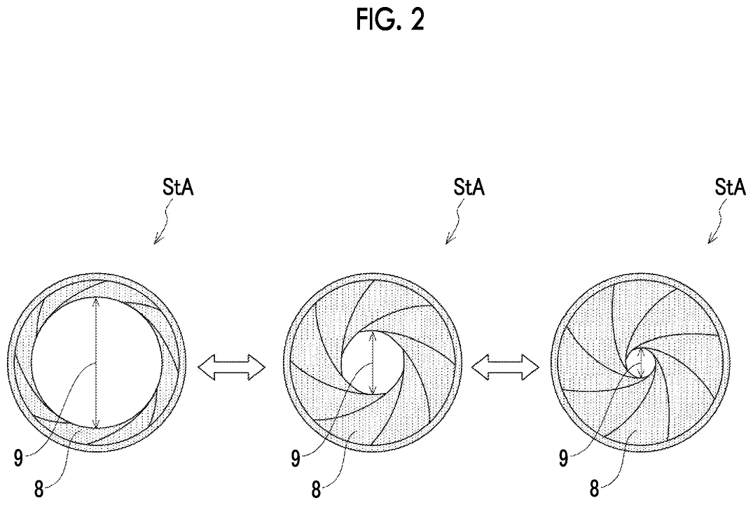

For example, as shown in FIG. 2 as an example, the stop StA has a plurality of stop blades 8 disposed at spacings on a circumference about the optical axis AX1 and thus can be configured to form an annular light blocking portion as a whole. A portion radially inside the light blocking portion is an opening portion and is a portion through which light passes. The opening portion has a substantially circular shape, and the diameter of the circular shape is an aperture diameter 9. By moving the plurality of stop blades 8 in the opening closing direction, the aperture diameter 9 changes as shown in FIG. 2. It should be noted that the stop StA in FIG. 2 has eight stop blades 8. However, in order to avoid complication of the drawing, reference numerals are attached to only one stop blade 8 in FIG. 2. The stop StB may also have the same configuration as the stop StA.

From the viewpoint of the above-mentioned heat resistance, it is preferable that the stop blade 8 included in the stop StA is made of metal. As the metal, for example, aluminum can be used. In a case where the stop blade 8 is made of metal, it is possible to ensure heat resistance such that there is no problem even in a case where the projection type display apparatus is exposed to strong light. Alternatively, the stop blade 8 included in the stop StA may be configured to be made of heat resistant resin. In such a case, the cost can be suppressed while ensuring the heat resistance. As the heat resistant resin, for example, a Somablack film (manufactured by Somar Corporation, a registered trademark) can be used. The above-mentioned configuration of the stop blade 8 with respect to the material is the same for the stop StB.

The projection optical system of the present disclosure may be configured to include a group that moves by changing a spacing between adjacent groups during magnification change, in a part different from the interchangeable optical system. In such a case, even in a case where the interchangeable optical system is a fixed focus optical system, the size of the projected image can be easily changed, and a highly convenient apparatus can be provided.

For example, in the example of FIG. 1, the second optical system U2 is a variable magnification optical system. The second optical system U2 of FIG. 1 consists of, in order from the magnification side to the reduction side, five lens groups including a first lens group G1, a second lens group G2, a third lens group G3, a fourth lens group G4, and a fifth lens group G5. During magnification change, the first lens group G1 remains stationary with respect to the image display surface 5a, and the other four lens groups move by changing the spacing between the adjacent groups. In FIG. 1, a ground symbol is shown below the lens group stationary during magnification change, and a direction of movement of each lens during magnification change from the wide angle end to the telephoto end is schematically indicated by an arrow below the lens group moving during the magnification change.

In the projection optical system of the present disclosure, assuming that a combined lateral magnification of lenses ranging from a lens closest to the magnification side among lenses, of which magnification side lens surfaces are located closer to the reduction side than the intermediate image MI closest to the reduction side, to a lens closest to the reduction side in the projection optical system is β, it is preferable to satisfy Conditional Expression (1). R is a value in a case where the magnification side is the object side and the reduction side is the image side. Further, R is a value at a wide angle end in a case where the projection optical system includes a variable magnification optical system. For example, in the example of FIG. 1, among the lenses in which the magnification side lens surface is located closer to the reduction side than the intermediate image MI, the lens closest to the magnification side is the lens closest to the magnification side in the first lens group G1. By not allowing the corresponding value of Conditional Expression (1) to be equal to or less than the lower limit thereof, there is an advantage in achieving reduction in size. By not allowing the corresponding value of Conditional Expression (1) to be equal to or greater than the upper limit thereof, it is possible to suppress the refractive power necessary for the optical system closer to the magnification side than the intermediate image MI from becoming excessively strong. Further, it is possible to prevent the F number necessary for the optical system closer to the magnification side than the intermediate image MI from becoming excessively small. As a result, there is an advantage in ensuring favorable performance. In order to obtain more favorable characteristics, it is more preferable that the projection optical system satisfies Conditional Expression (1-1).
0.25<|β|<2 (1)
0.4<|β|<1.5 (1-1)

The above-mentioned preferred configurations and available configurations including the configurations relating to Conditional Expressions may be any combination, and it is preferable to appropriately and selectively adopt the configurations in accordance with required specification. It should be noted that the conditional expressions that the projection optical system of the present disclosure preferably satisfies are not limited to the conditional expressions described in the form of the expression, and the lower limit and the upper limit are selected from the preferable and more preferable conditional expressions. The conditional expressions may include all conditional expressions obtained through optional combinations.

Next, examples of the projection optical system of the present disclosure will be described, with reference to the drawings. The reference numerals noted in the cross-sectional views of the examples and the modification examples are used independently for examples in order to avoid complication of description and drawings due to an increase in number of digits of the reference numerals. Therefore, even in a case where common reference numerals are attached in the drawings of different examples, components do not necessarily have a common configuration.

### Example 1

FIG. 1 is a cross-sectional view of a configuration and luminous flux of a projection optical system of Example 1, and an illustration method and a configuration thereof are as described above. Therefore, some description is not repeated herein. The projection optical system of Example 1 consists of the first optical system U1 and the second optical system U2, in order from the magnification side to the reduction side. The intermediate image MI is formed between the first optical system U1 and the second optical system U2. The first optical system U1 is interchangeable. The second optical system U2 corresponds to a relay optical system.

The first optical system U1 consists of seven lenses, a stop StB, and eight lenses, in order from the magnification side to the reduction side. The second optical system U2 consists of ten lenses, a stop StA, and three lenses, in order from the magnification side to the reduction side. The aperture diameter of the stop StA and the aperture diameter of the stop StB are variable. The second optical system U2 is a variable magnification optical system. The second optical system U2 consists of, in order from the magnification side to the reduction side, five lens groups, that is, a first lens group G1, a second lens group G2, a third lens group G3, a fourth lens group G4, and a fifth lens group G5. During magnification change, the first lens group G1 remains stationary with respect to the image display surface 5a, and the other four lens groups move by changing the spacing between the adjacent groups.

Regarding the projection optical system of Example 1, Tables 1A and 1B show basic lens data, Table 2 shows specifications and variable surface spacings, and Table 3 shows aspherical coefficients. Here, the basic lens data is shown to be divided into two tables, Table 1A and Table 1B, in order to avoid lengthening of one table.

The table of basic lens data will be described as follows. The Sn column shows surface numbers in a case where the surface closest to the magnification side is the first surface and the number is increased one by one toward the reduction side. The R column shows a curvature radius of each surface. The D column shows a surface spacing between each surface and the surface adjacent to the reduction side on the optical axis. The Nd column shows a refractive index of each component at the d line. The vd column shows an Abbe number of each component based on the d line. The rightmost column indicates the reference numerals of the optical systems constituting the projection optical system. For example, the column labeled U1 corresponds to the first optical system U1, and the column labeled U2 corresponds to the second optical system U2.

In the basic lens data, the sign of the curvature radius of the convex surface facing toward the magnification side is positive and the sign of the curvature radius of the convex surface facing toward the reduction side is negative. In a cell of a surface number of a surface corresponding to the stop StA, the surface number and a term of (StA) are noted. In a cell of a surface number of a surface corresponding to the stop StB, the surface number and a term of (StB) are noted. The optical member PP is also shown in the basic lens data. A value at the bottom cell of D in Table 1B indicates a spacing between the image display surface 5a and the surface closest to the reduction side in the table. In the table of basic lens data, the symbol DD[ ] is used for each variable surface spacing, and the magnification side surface number of the spacing is given in [ ] and is noted in the D column.

Table 2 shows the magnification change ratio Zr, the absolute value of the focal length |f|, the F number FNo., the maximum total angle of view 2ω, and the variable surface spacing during magnification change, on the basis of the d line. [° ] in the cells of 2ω indicates that the unit thereof is a degree. In Table 2, The “wide” and “tele” columns show values in the wide angle end state and the telephoto end state, respectively.

In basic lens data, a reference sign * is attached to surface numbers of aspherical surfaces, and numerical values of the paraxial curvature radius are written into the column of the curvature radius of the aspherical surface. In Table 3, the Sn row shows surface numbers of the aspherical surfaces, and the KA and Am rows show numerical values of the aspherical coefficients for each aspherical surface. It should be noted that m of Am is an integer of 3 or more, and differs depending on the surface. For example, in the twentieth surface of Example 1, m=3, 4, 5, . . . , and 14. The “E±n” (n: an integer) in numerical values of the aspherical coefficients of Table 3 indicates “×10^{±n}”. KA and Am are the aspherical coefficients in the aspherical surface expression represented by the following expression.

Zd=C×h²/{1+(1−KA×C²×h²)^{1/2}}+ΣAm×h^{m}

Here,
Zd is an aspherical surface depth (a length of a perpendicular from a point on an aspherical surface at height h to a plane that is perpendicular to the optical axis and that is in contact with the vertex of the aspherical surface),
h is a height (a distance from the optical axis to the lens surface),
C is a reciprocal of the paraxial curvature radius,
KA and Am are aspherical coefficients, and
Σ in the aspherical surface expression means the sum with respect to m.

In the data of each table, degrees are used as a unit of an angle, and millimeters (mm) are used as a unit of a length, but appropriate different units may be used since the optical system can be used even in a case where the system is enlarged or reduced in proportion. Further, each of the following tables shows numerical values rounded off to predetermined decimal places.

TABLE 1A
Example 1

| Sn | R | D | Nd | νd | |
|---|---|---|---|---|---|
| 1 | −887.4776 | 1.05 | 1.53996 | 59.73 | U1 |
| 2 | 41.1494 | 6.07 | | | |
| 3 | −41.1494 | 2.9 | 1.883 | 40.8 | |
| 4 | −29.0764 | 1.21 | 1.80809 | 22.76 | |
| 5 | 59.9485 | 2.43 | | | |
| 6 | 383.4806 | 5.21 | 1.883 | 40.8 | |
| 7 | −30.6142 | 1.24 | 1.5927 | 35.31 | |
| 8 | 30.6142 | 5.28 | 1.883 | 40.8 | |
| 9 | −205.8923 | 1.92 | | | |
| 10 | 57.3331 | 3.08 | 1.95906 | 17.47 | |
| 11 | −548.6944 | 4.53 | | | |
| 12(StB) | ∞ | 7.1 | | | |
| 13 | 20.3442 | 5.7 | 1.59282 | 68.62 | |
| 14 | −62.1811 | 1.01 | 1.53172 | 48.85 | |
| 15 | 19.7263 | 4.9315 | | | |
| 16 | −18.5053 | 0.9 | 1.71736 | 29.5 | |
| 17 | 41.418 | 2.78 | 1.6968 | 55.53 | |
| 18 | −131.9641 | 0.2 | | | |
| 19 | 26.3178 | 6.64 | 1.59282 | 68.62 | |
| 20 | −26.3178 | 1.21 | | | |
| *21 | −47.8136 | 2.75 | 1.80882 | 40.97 | |
| *22 | −29.9011 | 1.75 | | | |
| 23 | 41.9378 | 3.47 | 1.59282 | 68.62 | |
| 24 | −182.0569 | 0.1705 | | | |
| *25 | −96.5919 | 1.6 | 1.68948 | 31.02 | |
| *26 | 39.8918 | 30.6421 | | | |

TABLE 1B
Example 1

| Sn | R | D | Nd | νd | |
|---|---|---|---|---|---|
| *27 | −35.8154 | 1.6191 | 1.51633 | 64.14 | U2 |
| 28 | 123.2724 | 6.4042 | | | |
| 29 | −150.2106 | 6.4999 | 1.80518 | 25.46 | |
| 30 | −53.6143 | 0.3005 | | | |
| 31 | −105.4315 | 8.5002 | 2.001 | 29.13 | |
| *32 | −45.6348 | DD[32] | | | |
| 33 | 40.4727 | 9.5497 | 1.804 | 46.53 | |
| 34 | 95.5283 | 36.6878 | | | |
| 35 | 31.6615 | 2.9902 | 1.804 | 46.53 | |
| 36 | 64.5385 | 2.8589 | | | |
| 37 | −38.3431 | 0.8007 | 1.84666 | 23.78 | |
| 38 | 38.2396 | DD[38] | | | |
| 39 | −19.9218 | 1.001 | 1.84666 | 23.78 | |
| 40 | 248.8815 | 0.0594 | | | |
| 41 | 258.8251 | 6.8203 | 1.59522 | 67.73 | |
| 42 | −24.8823 | 0.3001 | | | |
| 43 | 243.8753 | 7.1139 | 1.53775 | 74.7 | |
| 44 | −33.8694 | 5.1522 | | | |
| 45 | 59.5977 | 5.6569 | 1.59522 | 67.73 | |
| 46 | −123.8267 | 3.3973 | | | |
| 47(StA) | ∞ | DD[47] | | | |
| 48 | −35.9547 | 1.2913 | 1.5927 | 35.31 | |
| 49 | 85.8401 | DD[49] | | | |
| 50 | −497.1762 | 5.3117 | 1.84666 | 23.78 | |
| 51 | −50.925 | 0.3 | | | |
| 52 | 55.0552 | 4.9991 | 2.001 | 29.13 | |
| 53 | 183.6523 | DD[53] | | | |
| 54 | ∞ | 26 | 1.51633 | 64.14 | |
| 55 | ∞ | 0 | | | |

TABLE 2
Example 1

| | wide | tele |
|---|---|---|
| Zr | 1 | 1.10 |
| \|f\| | 21.87 | 24.06 |
| FNo. | 2.21 | 2.33 |
| 2ω[°] | 64.8 | 59.8 |
| DD[32] | 3.94 | 2 |
| DD[38] | 11.66 | 9.21 |
| DD[47] | 23.77 | 26.88 |
| DD[49] | 7.56 | 6.93 |
| DD[53] | 32.85 | 34.77 |

TABLE 3
Example 1

| Sn | 21 | 22 | 25 | 26 |
|---|---|---|---|---|
| KA | 1 | 1 | 1 | 1 |
| A3 | 0 | 0 | 0 | 0 |
| A4 | −2.58897E−05 | 3.83181E−05 | 7.23649E−06 | −2.73961E−05 |
| A5 | −1.29825E−05 | −2.49E−05 | 5.02391E−06 | 3.67469E−05 |
| A6 | 3.96745E−06 | 6.2636E−06 | −2.18324E−07 | −1.01919E−05 |
| A7 | −3.33032E−07 | −3.80485E−07 | −2.73555E−07 | 1.12811E−06 |
| A8 | −3.63391E−08 | −7.24063E−08 | 3.95405E−08 | −5.49779E−09 |
| A9 | 8.35078E−09 | 1.16708E−08 | 1.07272E−09 | −1.0848E−08 |
| A10 | −8.88654E−11 | 5.63034E−11 | −4.47593E−10 | 1.02468E−09 |
| A11 | −6.18245E−11 | −8.98287E−11 | 1.20862E−11 | −1.87752E−11 |
| A12 | 2.49789E−12 | 2.88559E−12 | 1.41541E−12 | −3.35991E−12 |
| A13 | 1.54328E−13 | 2.26871E−13 | −6.69876E−14 | 2.74967E−13 |
| A14 | −8.60654E−15 | −1.12789E−14 | 1.62591E−17 | −6.89344E−15 |

| Sn | 27 | 32 |
|---|---|---|
| KA | −0.61835852 | 0.77097498 |
| A4 | 1.07752E−07 | −3.84931E−07 |
| A6 | −6.42455E−09 | −5.14596E−10 |
| A8 | 6.7999E−11 | 3.72886E−13 |
| A10 | −6.37604E−14 | −3.94517E−16 |

Symbols, meanings, description methods, and illustration methods of the respective data pieces according to Example 1 are basically similar to those in the following examples unless otherwise specified. Therefore, in the following description, repeated description will not be given.

### Example 2

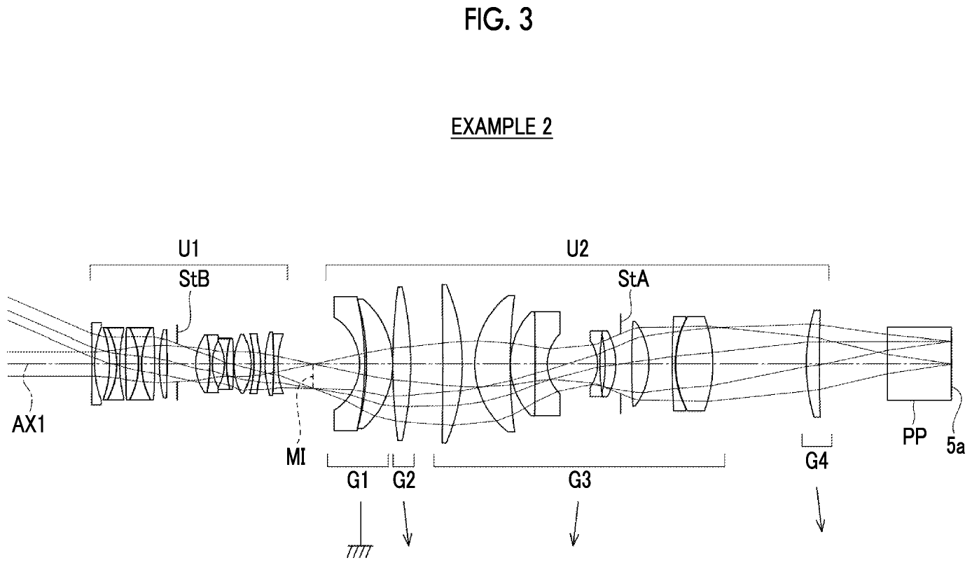

FIG. 3 shows a cross-sectional view of a configuration and luminous flux of a projection optical system of Example 2. The projection optical system of Example 2 consists of the first optical system U1 and the second optical system U2, in order from the magnification side to the reduction side. The intermediate image MI is formed between the first optical system U1 and the second optical system U2. The first optical system U1 is interchangeable. The second optical system U2 corresponds to a relay optical system.

The first optical system U1 consists of seven lenses, a stop StB, and eight lenses, in order from the magnification side to the reduction side. The second optical system U2 consists of nine lenses, a stop StA, and four lenses, in order from the magnification side to the reduction side. The aperture diameter of the stop StA and the aperture diameter of the stop StB are variable. The second optical system U2 is a variable magnification optical system. The second optical system U2 consists of, in order from the magnification side to the reduction side, four lens groups, that is, a first lens group G1, a second lens group G2, a third lens group G3, and a fourth lens group G4. During magnification change, the first lens group G1 remains stationary with respect to the image display surface 5a, and the other three lens groups move by changing the spacing between the adjacent groups.

Regarding the projection optical system of Example 2, Tables 4A and 4B show basic lens data, Table 5 shows specifications and variable surface spacings, and Table 6 shows aspherical coefficients.

TABLE 4A
Example 2

| Sn | R | D | Nd | νd | |
|---|---|---|---|---|---|
| 1 | −887.4776 | 1.05 | 1.53996 | 59.73 | U1 |
| 2 | 41.1494 | 6.07 | | | |
| 3 | −41.1494 | 2.9 | 1.883 | 40.8 | |
| 4 | −29.0764 | 1.21 | 1.80809 | 22.76 | |
| 5 | 59.9485 | 2.43 | | | |
| 6 | 383.4806 | 5.21 | 1.883 | 40.8 | |
| 7 | −30.6142 | 1.24 | 1.5927 | 35.31 | |
| 8 | 30.6142 | 5.28 | 1.883 | 40.8 | |
| 9 | −205.8923 | 1.92 | | | |
| 10 | 57.3331 | 3.08 | 1.95906 | 17.47 | |
| 11 | −548.6944 | 4.53 | | | |
| 12(StB) | ∞ | 7.1 | | | |
| 13 | 20.3442 | 5.7 | 1.59282 | 68.62 | |
| 14 | −62.1811 | 1.01 | 1.53172 | 48.85 | |
| 15 | 19.7263 | 4.9315 | | | |
| 16 | −18.5053 | 0.9 | 1.71736 | 29.5 | |
| 17 | 41.418 | 2.78 | 1.6968 | 55.53 | |
| 18 | −131.9641 | 0.2 | | | |
| 19 | 26.3178 | 6.64 | 1.59282 | 68.62 | |
| 20 | −26.3178 | 1.21 | | | |
| *21 | −47.8136 | 2.75 | 1.80882 | 40.97 | |
| *22 | −29.9011 | 1.75 | | | |
| 23 | 41.9378 | 3.47 | 1.59282 | 68.62 | |
| 24 | −182.0569 | 0.1705 | | | |
| *25 | −96.5919 | 1.6 | 1.68948 | 31.02 | |
| *26 | 39.8918 | 33.095 | | | |

TABLE 4B
Example 2

| Sn | R | D | Nd | νd | |
|---|---|---|---|---|---|
| 27 | −22.2344 | 2 | 1.51742 | 52.43 | U2 |
| 28 | −120.2883 | 0.7878 | | | |
| 29 | −94.1966 | 10.6176 | 1.92286 | 20.88 | |
| 30 | −34.4009 | DD[30] | | | |
| 31 | 231.9183 | 7.2253 | 1.5927 | 35.31 | |
| 32 | −139.668 | DD[32] | | | |
| 33 | −1840.4421 | 7.8756 | 1.56883 | 56.04 | |
| 34 | −81.7427 | 5.0456 | | | |
| 35 | 34.7603 | 14.3168 | 1.58913 | 61.13 | |
| 36 | 208.8103 | 0.05 | | | |
| 37 | 30.2066 | 10.0009 | 1.497 | 81.61 | |
| 38 | −2862.8707 | 0.0505 | | | |
| 39 | −1631.7423 | 4.9595 | 1.80518 | 25.46 | |
| 40 | 16.6927 | 20.3513 | | | |
| 41 | −16.1964 | 1 | 1.72825 | 28.46 | |
| 42 | 88.6931 | 2.0739 | | | |
| 43 | −58.7465 | 4.3871 | 1.72916 | 54.68 | |
| 44 | −26.9001 | 1.9231 | | | |
| 45(StA) | ∞ | 4.5 | | | |
| 46 | 327.9031 | 6.9629 | 1.59282 | 68.62 | |
| 47 | −28.7163 | 9.4051 | | | |
| 48 | 279.5711 | 1.2 | 1.62004 | 36.26 | |
| 49 | 39.1756 | 0.2773 | | | |
| 50 | 40.4307 | 15.0009 | 1.497 | 81.61 | |
| 51 | −54.4655 | DD[51] | | | |
| 52 | 74.733 | 5.3359 | 1.92286 | 20.88 | |
| 53 | 825.5497 | DD[53] | | | |
| 54 | ∞ | 26 | 1.5168 | 64.2 | |
| 55 | ∞ | 0 | | | |

TABLE 5
Example 2

| | wide | tele |
|---|---|---|
| Zr | 1 | 1.05 |
| \|f\| | 21.87 | 22.97 |
| FNo. | 2.21 | 2.27 |
| 2ω[°] | 64.8 | 62.2 |
| DD[30] | 0.05 | 1.7 |
| DD[32] | 13.07 | 6.65 |
| DD[51] | 37.67 | 42.75 |
| DD[53] | 27.47 | 27.14 |

TABLE 6
Example 2

| Sn | 21 | 22 | 25 | 26 |
|---|---|---|---|---|
| KA | 1 | 1 | 1 | 1 |
| A3 | 0 | 0 | 0 | 0 |
| A4 | −2.58897E−05 | 3.83181E−05 | 7.23649E−06 | −2.73961E−05 |
| A5 | −1.29825E−05 | −2.49E−05 | 5.02391E−06 | 3.67469E−05 |
| A6 | 3.96745E−06 | 6.2636E−06 | −2.18324E−07 | −1.01919E−05 |
| A7 | −3.33032E−07 | −3.80485E−07 | −2.73555E−07 | 1.12811E−06 |
| A8 | −3.63391E−08 | −7.24063E−08 | 3.95405E−08 | −5.49779E−09 |
| A9 | 8.35078E−09 | 1.16708E−08 | 1.07272E−09 | −1.0848E−08 |
| A10 | −8.88654E−11 | 5.63034E−11 | −4.47593E−10 | 1.02468E−09 |
| A11 | −6.18245E−11 | −8.98287E−11 | 1.20862E−11 | −1.87752E−11 |
| A12 | 2.49789E−12 | 2.88559E−12 | 1.41541E−12 | −3.35991E−12 |
| A13 | 1.54328E−13 | 2.26871E−13 | −6.69876E−14 | 2.74967E−13 |
| A14 | −8.60654E−15 | −1.12789E−14 | 1.62591E−17 | −6.89344E−15 |

### Example 3

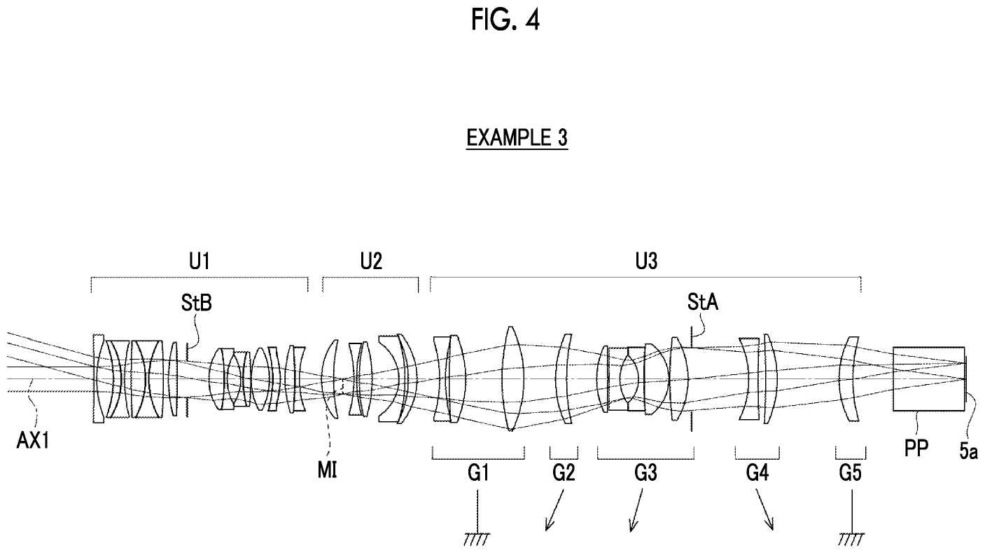

FIG. 4 shows a cross-sectional view of a configuration and luminous flux of a projection optical system of Example 3. The projection optical system of Example 3 consists of the first optical system U1, the second optical system U2, and the third optical system U3, in order from the magnification side to the reduction side. The intermediate image MI is formed inside the second optical system U2. The first optical system U1 is interchangeable. The second optical system U2 has a function of a field lens. The third optical system U3 corresponds to a relay optical system.

The first optical system U1 consists of seven lenses, a stop StB, and eight lenses, in order from the magnification side to the reduction side. The second optical system U2 consists of five lenses. The third optical system U3 consists of nine lenses, a stop StA, and three lenses, in order from the magnification side to the reduction side. The aperture diameter of the stop StA and the aperture diameter of the stop StB are variable. The third optical system U3 is a variable magnification optical system. The third optical system U3 consists of, in order from the magnification side to the reduction side, five lens groups, that is, a first lens group G1, a second lens group G2, a third lens group G3, a fourth lens group G4, and a fifth lens group G5. During magnification change, the first lens group G1 and the fifth lens group G5 remain stationary with respect to the image display surface 5a, and the other three lens groups move by changing the spacing between the adjacent groups.

Regarding the projection optical system of Example 3, Tables 7A and 7B show basic lens data, Table 8 shows specifications and variable surface spacings, and Table 9 shows aspherical coefficients.

TABLE 7A
Example 3

| Sn | R | D | Nd | νd | |
|---|---|---|---|---|---|
| 1 | −887.4776 | 1.05 | 1.53996 | 59.73 | U1 |
| 2 | 41.1494 | 6.07 | | | |
| 3 | −41.1494 | 2.9 | 1.883 | 40.8 | |
| 4 | −29.0764 | 1.21 | 1.80809 | 22.76 | |
| 5 | 59.9485 | 2.43 | | | |
| 6 | 383.4806 | 5.21 | 1.883 | 40.8 | |
| 7 | −30.6142 | 1.24 | 1.5927 | 35.31 | |
| 8 | 30.6142 | 5.28 | 1.883 | 40.8 | |
| 9 | −205.8923 | 1.92 | | | |
| 10 | 57.3331 | 3.08 | 1.95906 | 17.47 | |
| 11 | −548.6944 | 4.53 | | | |
| 12(StB) | ∞ | 7.1 | | | |
| 13 | 20.3442 | 5.7 | 1.59282 | 68.62 | |
| 14 | −62.1811 | 1.01 | 1.53172 | 48.85 | |
| 15 | 19.7263 | 4.9315 | | | |
| 16 | −18.5053 | 0.9 | 1.71736 | 29.5 | |
| 17 | 41.418 | 2.78 | 1.6968 | 55.53 | |
| 18 | −131.9641 | 0.2 | | | |
| 19 | 26.3178 | 6.64 | 1.59282 | 68.62 | |
| 20 | −26.3178 | 1.21 | | | |
| *21 | −47.8136 | 2.75 | 1.80882 | 40.97 | |
| *22 | −29.9011 | 1.75 | | | |
| 23 | 41.9378 | 3.47 | 1.59282 | 68.62 | |
| 24 | −182.0569 | 0.1705 | | | |
| *25 | −96.5919 | 1.6 | 1.68948 | 31.02 | |
| *26 | 39.8918 | 8.0853 | | | |
| *27 | 28.0493 | 4.379 | 1.854 | 40.38 | U2 |
| 28 | 66.556 | 7.4833 | | | |
| 29 | −48.489 | 1 | 1.85451 | 25.15 | |
| 30 | 52.694 | 0.9053 | | | |
| 31 | 62.0634 | 4.7244 | 1.95375 | 32.32 | |
| 32 | −50.838 | 9.8098 | | | |
| 33 | −16.9772 | 2.2093 | 1.48749 | 70.24 | |
| 34 | −54.4931 | 1.2035 | | | |
| 35 | −36.285 | 3.2449 | 1.79952 | 42.24 | |
| 36 | −26.8901 | 8.2531 | | | |

TABLE 7B
Example 3

| Sn | R | D | Nd | νd | |
|---|---|---|---|---|---|
| 37 | −48.6352 | 2.1212 | 1.76182 | 26.52 | U3 |
| 38 | 62.9654 | 1.3584 | | | |
| 39 | 267.1389 | 6.0004 | 1.92286 | 20.88 | |
| 40 | −43.7191 | 13.1063 | | | |
| 41 | 78.1151 | 8.0004 | 1.59522 | 67.73 | |
| 42 | −46.4684 | DD[42] | | | |
| 43 | 41.4532 | 3.9992 | 1.80518 | 25.46 | |
| 44 | 76.4252 | DD[44] | | | |
| 45 | 30.2235 | 3.9996 | 1.72916 | 54.68 | |
| 46 | −1533.7002 | 0.4444 | | | |
| 47 | 6530.8583 | 4.0009 | 1.84666 | 23.78 | |
| 48 | 15.7842 | 6.8732 | | | |
| 49 | −12.4913 | 2.0009 | 1.84666 | 23.78 | |
| 50 | 202.2293 | 0.0309 | | | |
| 51 | 189.7227 | 9.0476 | 1.497 | 81.54 | |
| 52 | −16.9226 | 0.3002 | | | |
| 53 | 127.4894 | 6.711 | 1.59522 | 67.73 | |
| 54 | −31.5684 | 1.34 | | | |
| 55(StA) | ∞ | DD[55] | | | |
| 56 | −35.0761 | 3.4292 | 1.48749 | 70.24 | |
| 57 | 307.6737 | 2.7715 | | | |
| 58 | −280.2248 | 4.219 | 1.883 | 40.8 | |
| 59 | −41.4744 | DD[59] | | | |
| 60 | 35.364 | 4.9998 | 1.92286 | 20.88 | |
| 61 | 57.9114 | 14.9306 | | | |
| 62 | ∞ | 26 | 1.51633 | 64.14 | |
| 63 | ∞ | 0.48 | | | |

TABLE 8
Example 3

| | wide | tele |
|---|---|---|
| Zr | 1 | 1.10 |
| \|f\| | 21.61 | 23.76 |
| FNo. | 2.34 | 2.42 |
| 2ω[°] | 44.2 | 40.6 |
| DD[42] | 11.55 | 4 |
| DD[44] | 11.04 | 14.84 |
| DD[55] | 20.83 | 43.2 |
| DD[59] | 22.61 | 4 |

TABLE 9
Example 3

| Sn | 21 | 22 | 25 | 26 |
|---|---|---|---|---|
| KA | 1 | 1 | 1 | 1 |
| A3 | 0 | 0 | 0 | 0 |
| A4 | −2.58897E−05 | 3.83181E−05 | 7.23649E−06 | −2.73961E−05 |
| A5 | −1.29825E−05 | −2.49E−05 | 5.02391E−06 | 3.67469E−05 |
| A6 | 3.96745E−06 | 6.2636E−06 | −2.18324E−07 | −1.01919E−05 |
| A7 | −3.33032E−07 | −3.80485E−07 | −2.73555E−07 | 1.12811E−06 |
| A8 | −3.63391E−08 | −7.24063E−08 | 3.95405E−08 | −5.49779E−09 |
| A9 | 8.35078E−09 | 1.16708E−08 | 1.07272E−09 | −1.0848E−08 |
| A10 | −8.88654E−11 | 5.63034E−11 | −4.47593E−10 | 1.02468E−09 |
| A11 | −6.18245E−11 | −8.98287E−11 | 1.20862E−11 | −1.87752E−11 |
| A12 | 2.49789E−12 | 2.88559E−12 | 1.41541E−12 | −3.35991E−12 |
| A13 | 1.54328E−13 | 2.26871E−13 | −6.69876E−14 | 2.74967E−13 |
| A14 | −8.60654E−15 | −1.12789E−14 | 1.62591E−17 | −6.89344E−15 |

| Sn | 27 |
|---|---|
| KA | 1.7733784 |
| A4 | 5.63595E−06 |
| A6 | 8.11156E−09 |
| A8 | −7.17724E−11 |
| A10 | 9.13509E−13 |
| A12 | −2.90729E−15 |
| A14 | −3.00509E−19 |
| A16 | 2.52662E−20 |

### Example 4

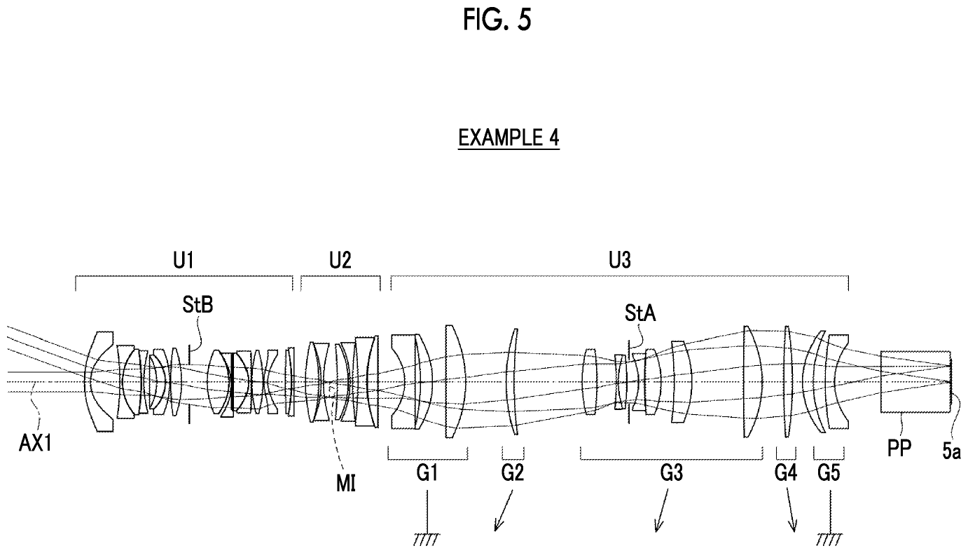

FIG. 5 shows a cross-sectional view of a configuration and luminous flux of a projection optical system of Example 4. The projection optical system of Example 4 consists of the first optical system U1, the second optical system U2, and the third optical system U3, in order from the magnification side to the reduction side. The intermediate image MI is formed inside the second optical system U2. The first optical system U1 is interchangeable. The second optical system U2 has a function of a field lens. The third optical system U3 corresponds to a relay optical system.

The first optical system U1 consists of seven lenses, a stop StB, and eight lenses, in order from the magnification side to the reduction side. The second optical system U2 consists of six lenses. The third optical system U3 consists of seven lenses, a stop StA, and seven lenses, in order from the magnification side to the reduction side. The aperture diameter of the stop StA and the aperture diameter of the stop StB are variable. The third optical system U3 is a variable magnification optical system. The third optical system U3 consists of, in order from the magnification side to the reduction side, five lens groups, that is, a first lens group G1, a second lens group G2, a third lens group G3, a fourth lens group G4, and a fifth lens group G5. During magnification change, the first lens group G1 and the fifth lens group G5 remain stationary with respect to the image display surface 5a, and the other three lens groups move by changing the spacing between the adjacent groups.

Regarding the projection optical system of Example 4, Tables 10A and 10B show basic lens data, Table 11 shows specifications and variable surface spacings, and Table 12 shows aspherical coefficients.

TABLE 10A
Example 4

| Sn | R | D | Nd | νd | |
|---|---|---|---|---|---|
| *1 | 42.5066 | 2.26 | 1.58313 | 59.46 | U1 |
| *2 | 14.3565 | 11.0287 | | | |
| 3 | −100.1648 | 1.02 | 1.58313 | 59.46 | |
| 4 | 18.6299 | 7.05 | 1.8919 | 37.13 | |
| 5 | −75.498 | 0.97 | 1.48749 | 70.42 | |
| 6 | 42.5062 | 4.8671 | | | |
| *7 | −20.6839 | 3.28 | 1.58254 | 59.44 | |
| 8 | −13.9817 | 1.66 | 2.00069 | 25.43 | |
| 9 | −31.4975 | 0.3 | | | |
| 10 | 89.0372 | 4.11 | 1.95375 | 32.32 | |
| 11 | −38.477 | 3.139 | | | |
| 12(StB) | ∞ | 6.58 | | | |
| 13 | 28.6629 | 8.18 | 1.59282 | 68.62 | |
| 14 | −19.7999 | 0.91 | 1.85451 | 25.15 | |
| 15 | ∞ | 0.4007 | | | |
| 16 | ∞ | 5.85 | 1.7725 | 49.61 | |
| 17 | −15.454 | 1.09 | 1.85451 | 25.15 | |
| 18 | −209.9846 | 0.1389 | | | |
| 19 | 45.3596 | 4.16 | 2.00272 | 19.32 | |
| 20 | −45.3596 | 0.4 | | | |
| *21 | 16.1711 | 1.3856 | 1.8061 | 40.73 | |
| *22 | 11.0173 | 6.7182 | | | |
| 23 | 363.2443 | 2.28 | 1.603 | 65.46 | |
| 24 | −62.1067 | 0.92 | 1.84666 | 23.78 | |
| 25 | ∞ | 4.3784 | | | |
| 26 | 63.289 | 5.0011 | 2.001 | 29.13 | U2 |
| 27 | −53.1686 | 0.8717 | | | |
| 28 | −37.8549 | 0.9 | 1.437 | 95.1 | |
| 29 | 48.1168 | 5.2002 | | | |
| 30 | −138.0137 | 4.1075 | 1.83481 | 42.72 | |
| 31 | −30.9753 | 0.6929 | | | |
| 32 | −32.8499 | 0.95 | 1.5927 | 35.31 | |
| 33 | 105.8669 | 2.0291 | | | |
| 34 | −109.6558 | 3.2743 | 1.437 | 95.1 | |
| 35 | 47.4634 | 0.2013 | | | |
| 36 | 50.7169 | 4.0353 | 2.001 | 29.13 | |
| 37 | ∞ | 10.0759 | | | |

TABLE 10B
Example 4

| Sn | R | D | Nd | νd | |
|---|---|---|---|---|---|
| 38 | −19.0393 | 3.9585 | 1.5927 | 35.31 | U3 |
| 39 | 00 | 1.962 | | | |
| 40 | −73.0867 | 4.5899 | 1.94595 | 17.98 | |
| 41 | −32.5747 | 5.0336 | | | |
| 42 | ∞ | 7.4178 | 1.83481 | 42.72 | |
| 43 | −45.8623 | DD[43] | | | |
| 44 | 62.8123 | 2.9675 | 1.883 | 40.8 | |
| 45 | 149.7608 | DD[45] | | | |
| 46 | 47.8227 | 5.616 | 1.55032 | 75.5 | |
| 47 | −99.642 | 7.2695 | | | |
| 48 | −89.0043 | 0.7491 | 1.94595 | 17.98 | |
| 49 | 30.4925 | 1.0149 | | | |
| 50 | 92.0937 | 2.1798 | 1.61997 | 63.88 | |
| 51 | −92.0937 | 0.8002 | | | |
| 52(StA) | ∞ | 3.6517 | | | |
| 53 | −22.6386 | 2.1915 | 1.94595 | 17.98 | |
| 54 | 112.2778 | 0.2996 | | | |
| 55 | 267.2568 | 5.9997 | 1.61997 | 63.88 | |
| 56 | −30.8926 | 4.9087 | | | |
| 57 | −119.0496 | 6.7004 | 1.61997 | 63.88 | |
| 58 | −37.7053 | 19.2457 | | | |
| 59 | 836.1454 | 6.9992 | 1.437 | 95.1 | |
| 60 | −42.6133 | DD[60] | | | |
| 61 | 288.0247 | 3.2726 | 1.94595 | 17.98 | |
| 62 | −148.4147 | DD[62] | | | |
| 63 | 29.4375 | 3.9992 | 2.001 | 29.13 | |
| 64 | 41.8267 | 4.5426 | | | |
| 65 | 100.0001 | 3.5 | 1.5168 | 64.2 | |
| 66 | 23.4342 | 17.4951 | | | |
| 67 | ∞ | 26 | 1.51633 | 64.14 | |
| 68 | ∞ | 0.54 | | | |

TABLE 11
Example 4

| | wide | tele |
|---|---|---|
| Zr | 1 | 1.10 |
| \|f\| | 16.41 | 18.05 |
| FNo. | 2.23 | 2.3 |
| 2ω[°] | 55.2 | 50.8 |
| DD[43] | 15.27 | 3.02 |
| DD[45] | 25.64 | 30.26 |
| DD[60] | 8.1 | 16.57 |
| DD[62] | 3.86 | 3.02 |

TABLE 12
Example 4

| Sn | 1 | 2 | 7 | 21 | 22 |
|---|---|---|---|---|---|
| KA | 3.8510739 | −4.3296751 | −3.0025953 | −5.0000027 | −1.4211109 |
| A3 | 0 | 0 | 0 | 0 | 0 |
| A4 | 8.21013E−05 | 0.000310699 | −5.99947E−05 | −1.56899E−05 | 3.0066E−05 |
| A5 | −9.574E−06 | −1.0193E−05 | 6.16895E−07 | −6.58027E−06 | −1.94313E−05 |
| A6 | 5.95886E−07 | −9.90291E−07 | −1.27982E−06 | −6.92551E−07 | 3.3139E−06 |
| A7 | −3.0456E−08 | 7.41659E−09 | 3.93277E−07 | 1.44799E−08 | −4.37164E−07 |
| A8 | −1.94805E−09 | 5.81716E−09 | −3.45978E−08 | 1.41227E−08 | 2.81052E−08 |
| A9 | 4.08645E−10 | 1.70377E−10 | −2.39255E−09 | −3.49649E−10 | 1.7441E−09 |
| A10 | −1.49197E−11 | −1.63212E−11 | 3.71505E−10 | −7.55908E−11 | −1.54175E−10 |
| A11 | −1.82577E−13 | −1.49036E−12 | 3.90669E−11 | 6.11732E−12 | −2.30688E−11 |
| A12 | −2.71477E−14 | −2.87462E−13 | −6.39448E−12 | −9.66037E−13 | 1.28151E−12 |
| A13 | 3.46186E−15 | 5.17533E−14 | −1.99555E−13 | 7.72513E−14 | 2.3111E−13 |
| A14 | −2.72278E−18 | −2.52859E−15 | 7.42065E−14 | 1.11076E−15 | −2.73713E−14 |
| A15 | −6.67053E−18 | 4.08089E−17 | −4.36547E−15 | −3.0215E−16 | 1.20108E−15 |
| A16 | 1.49943E−19 | −8.79931E−21 | 7.94244E−17 | 7.84654E−18 | −2.14997E−17 |

### Example 5

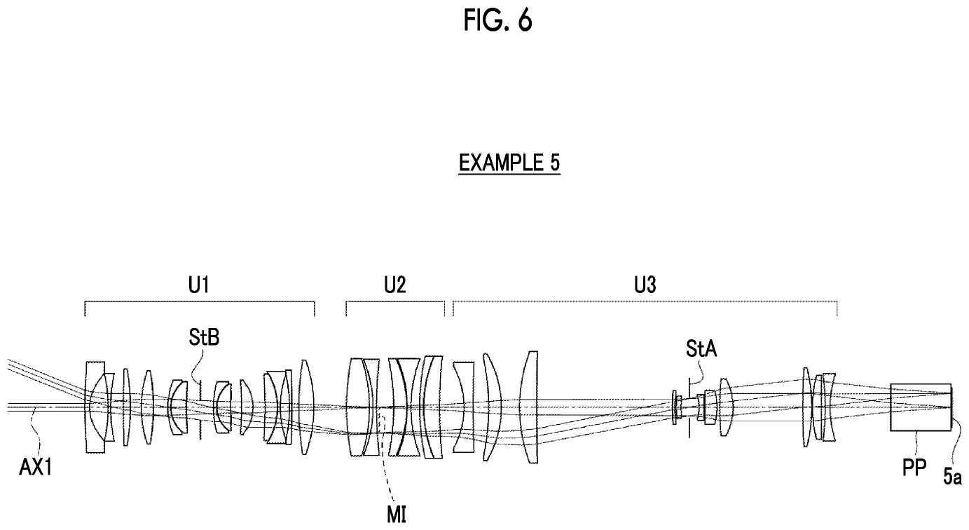

FIG. 6 shows a cross-sectional view of a configuration and luminous flux of a projection optical system of Example 5. The projection optical system of Example 5 consists of the first optical system U1, the second optical system U2, and the third optical system U3, in order from the magnification side to the reduction side. The intermediate image MI is formed inside the second optical system U2. The first optical system U1 is interchangeable. The second optical system U2 has a function of a field lens. The third optical system U3 corresponds to a relay optical system.

The first optical system U1 consists of six lenses, a stop StB, and seven lenses, in order from the magnification side to the reduction side. The second optical system U2 consists of five lenses. The third optical system U3 consists of five lenses, a stop StA, and six lenses, in order from the magnification side to the reduction side. The aperture diameter of the stop StA and the aperture diameter of the stop StB are variable.

Regarding the projection optical system of Example 5, Tables 13A and 13B show basic lens data, Table 14 shows specification, and Table 15 shows the aspherical coefficients thereof.

TABLE 13A
Example 5

| Sn | R | D | Nd | νd | |
|---|---|---|---|---|---|
| *1 | 131.2588 | 2 | 1.85108 | 40.12 | U1 |
| *2 | 16.6936 | 8.02 | | | |
| 3 | −66.8654 | 1.07 | 1.497 | 81.59 | |
| 4 | 66.8654 | 5.45 | | | |
| 5 | 438.5292 | 3.05 | 1.7847 | 26.29 | |
| 6 | −99.1927 | 4.69 | | | |
| 7 | 49.0218 | 5.25 | 1.7859 | 44.21 | |
| 8 | −89.7385 | 6.19 | | | |
| 9 | 30.2674 | 1.29 | 1.79952 | 42.25 | |
| 10 | 13.865 | 6.75 | 1.62299 | 58.16 | |
| 11 | 179.2836 | 6.56 | | | |
| 12(StB) | ∞ | 5 | | | |
| 13 | 38.6448 | 1.5 | 1.95375 | 32.32 | |
| 14 | 12.429 | 5.99 | 1.497 | 81.59 | |
| 15 | 348.9318 | 4.67 | | | |
| *16 | −153.0689 | 4.68 | 1.58135 | 59.38 | |
| *17 | −18.2765 | 5.22 | | | |
| 18 | −161.7627 | 5.34 | 2.00272 | 19.32 | |
| 19 | −28.43 | 1.21 | 1.738 | 32.33 | |
| 20 | 42.001 | 3.9 | | | |
| 21 | −67.5416 | 1.02 | 1.94595 | 17.98 | |
| 22 | −425.6597 | 3.05 | | | |
| 23 | 125.0308 | 6.5 | 1.56883 | 56.06 | |
| 24 | −60.3989 | 14.0062 | | | |
| 25 | 105.514 | 9.8587 | 2.001 | 29.13 | U2 |
| 26 | −68.622 | 1.5674 | | | |
| 27 | −53.9344 | 1.4999 | 1.437 | 95.1 | |
| 28 | 179.0608 | 7.3985 | | | |
| 29 | −97.5586 | 5.6457 | 2.001 | 29.13 | |
| 30 | −48.901 | 0.2298 | | | |
| 31 | −53.1228 | 1.6 | 1.5927 | 35.31 | |
| 32 | 58.4484 | 3.6987 | | | |
| 33 | 103.0331 | 1.715 | 1.437 | 95.1 | |
| 34 | 55.5622 | 6.8536 | 2.001 | 29.13 | |
| 35 | 195.6947 | 10.5846 | | | |

TABLE 13B
Example 5

| Sn | R | D | Nd | νd | |
|---|---|---|---|---|---|
| 36 | −36.6613 | 3.9489 | 1.48749 | 70.44 | U3 |
| 37 | 748.0417 | 6.6654 | | | |
| 38 | −97.3372 | 5.4286 | 1.94595 | 17.98 | |
| 39 | −45.452 | 7.8434 | | | |
| 40 | 67.7237 | 7.3864 | 2.001 | 29.13 | |
| 41 | 888.1907 | 58.4478 | | | |
| 42 | 85.3259 | 0.9801 | 1.94595 | 17.98 | |
| 43 | 22.4865 | 0.6127 | | | |
| 44 | 29.0303 | 2.1162 | 1.883 | 40.8 | |
| 45 | 75.0801 | 3.5524 | | | |
| 46(StA) | ∞ | 4.207 | | | |
| 47 | −15.3336 | 2.1074 | 1.94595 | 17.98 | |
| 48 | 266.2112 | 0.4852 | | | |
| 49 | −161.31 | 5.1427 | 1.8042 | 46.5 | |
| 50 | −24.8581 | 1.1618 | | | |
| 51 | 118.3121 | 5.5268 | 1.55032 | 75.5 | |
| 52 | −25.5488 | 30.0148 | | | |
| 53 | 282.2034 | 3.8448 | 1.94595 | 17.98 | |
| 54 | −71.3177 | 0.2991 | | | |
| 55 | 54.0697 | 3.9407 | 2.001 | 29.13 | |
| 56 | 2264.8782 | 1.5699 | | | |
| 57 | −104.2353 | 2.0954 | 1.5927 | 35.31 | |
| 58 | 46.1733 | 26.0357 | | | |
| 59 | ∞ | 26 | 1.51633 | 64.14 | |
| 60 | ∞ | 0.4868 | | | |

TABLE 14
Example 5

| | |
|---|---|
| \|f\| | 14.9 |
| FNo. | 4.45 |
| 2ω[°] | 59.8 |

TABLE 15
Example 5

| Sn | 1 | 2 | 16 | 17 |
|---|---|---|---|---|
| KA | 1 | 1 | 1 | 1 |
| A3 | 0 | 0 | 0 | 0 |
| A4 | −2.88869E−06 | −1.92669E−05 | 1.14264E−10 | 2.12864E−05 |
| A5 | −6.53067E−07 | −6.81363E−07 | −5.74281E−06 | −1.13361E−05 |
| A6 | 2.01274E−08 | −5.13868E−08 | −5.19738E−08 | 3.2649E−06 |
| A7 | 1.39077E−09 | 1.54352E−09 | 2.96352E−07 | −7.1293E−07 |
| A8 | 1.31042E−11 | −1.88231E−10 | −1.82378E−08 | 1.08566E−07 |
| A9 | −2.3166E−12 | 1.2882E−11 | −9.47169E−09 | −4.71334E−09 |
| A10 | −1.5905E−13 | −5.84334E−14 | 8.35984E−10 | −1.94544E−09 |
| A11 | −3.50692E−15 | −9.24618E−14 | 2.14061E−10 | 3.30128E−10 |
| A12 | −4.01125E−17 | 1.15862E−14 | −2.26034E−11 | 1.34228E−12 |
| A13 | −1.34827E−18 | −1.36018E−15 | −2.79336E−12 | −3.78129E−12 |
| A14 | 2.34309E−18 | 2.33962E−17 | 3.2182E−13 | 9.44705E−14 |
| A15 | 7.87387E−20 | 4.62004E−18 | 2.28722E−14 | 3.16636E−14 |
| A16 | 6.06888E−21 | −9.16173E−19 | −2.63326E−15 | −1.70213E−15 |
| A17 | −5.84253E−22 | 7.75557E−20 | −1.05543E−16 | −9.41954E−17 |
| A18 | −6.84123E−23 | −3.52457E−22 | 9.12283E−18 | 6.02891E−18 |
| A19 | 4.741E−24 | −1.73537E−22 | 6.25118E−19 | 2.02666E−19 |
| A20 | −7.16013E−26 | 3.7489E−24 | −3.90513E−20 | −1.21798E−20 |

### Modification Example of Example 5

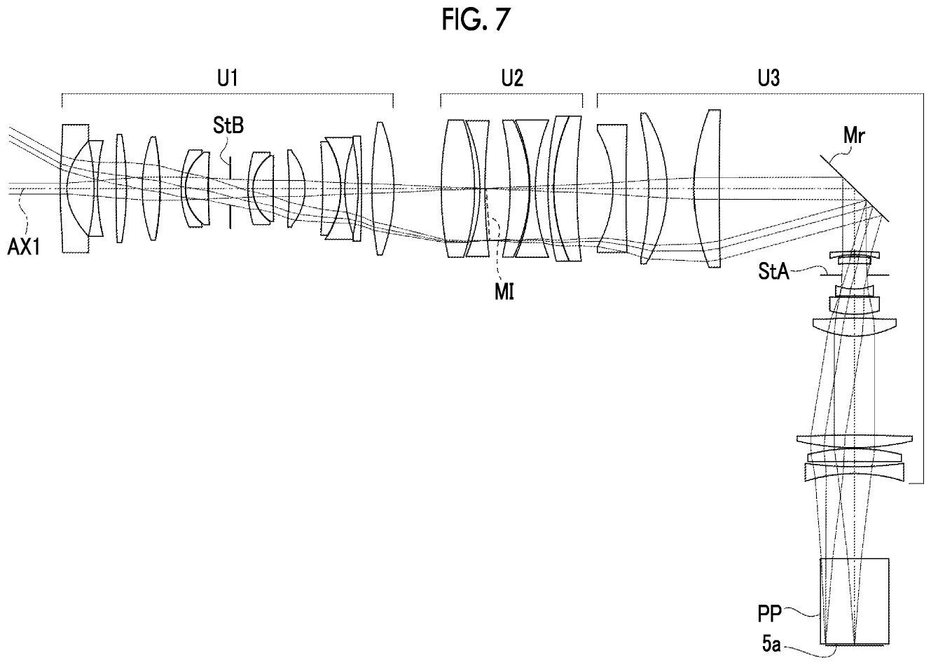

FIG. 7 shows a configuration and luminous flux of a projection optical system according to a modification example of the Example 5. The third optical system U3 of the modification example of FIG. 7 is different from the third optical system U3 of the projection optical system of Example 5 in that the third optical system U3 includes a mirror Mr which is an optical path deflection member and the optical path is deflected by the mirror Mr. Other configurations of the projection optical system of FIG. 7 are the same as the configurations of the projection optical system of Example 5. The spacing between the 41st surface and the mirror Mr on the optical axis is 40 millimeters (mm). By deflecting the optical path, a compact configuration is possible.

### Example 6

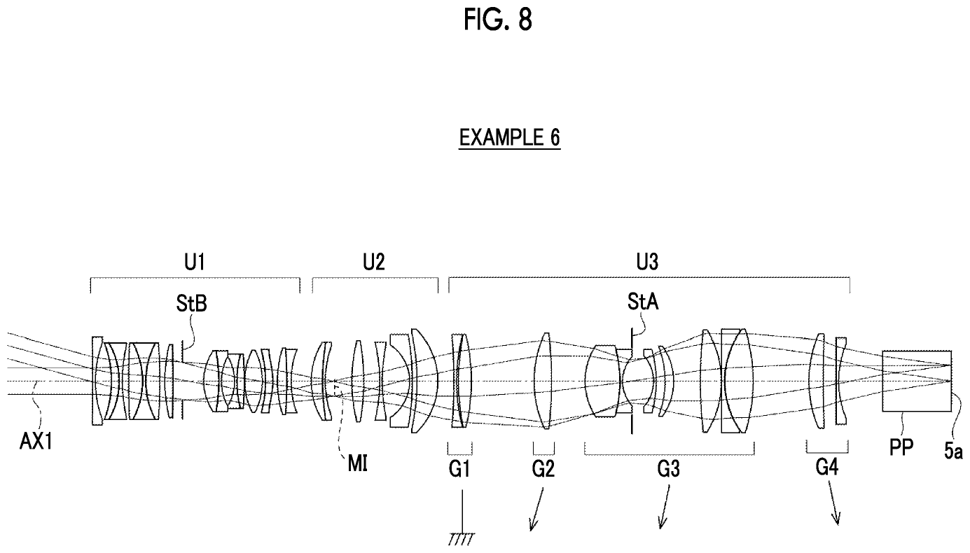

FIG. 8 shows a cross-sectional view of a configuration and luminous flux of a projection optical system of Example 6. The projection optical system of Example 6 consists of the first optical system U1, the second optical system U2, and the third optical system U3, in order from the magnification side to the reduction side. The intermediate image MI is formed inside the second optical system U2. The first optical system U1 is interchangeable. The second optical system U2 has a function of a field lens. The third optical system U3 corresponds to a relay optical system.

The first optical system U1 consists of seven lenses, a stop StB, and eight lenses, in order from the magnification side to the reduction side. The second optical system U2 consists of six lenses. The third optical system U3 consists of five lenses, a stop StA, and seven lenses, in order from the magnification side to the reduction side. The aperture diameter of the stop StA and the aperture diameter of the stop StB are variable. The third optical system U3 is a variable magnification optical system. The third optical system U3 consists of, in order from the magnification side to the reduction side, four lens groups, that is, a first lens group G1, a second lens group G2, a third lens group G3, and a fourth lens group G4. During magnification change, the first lens group G1 remains stationary with respect to the image display surface 5a, and the other three lens groups move by changing the spacing between the adjacent groups.

Regarding the projection optical system of Example 6, Tables 16A and 16B show basic lens data, Table 17 shows specifications and variable surface spacings, and Table 18 shows aspherical coefficients.

TABLE 16A
Example 6

| Sn | R | D | Nd | νd | |
|---|---|---|---|---|---|
| 1 | −887.4776 | 1.05 | 1.53996 | 59.73 | U1 |
| 2 | 41.1494 | 6.07 | | | |
| 3 | −41.1494 | 2.9 | 1.883 | 40.8 | |
| 4 | −29.0764 | 1.21 | 1.80809 | 22.76 | |
| 5 | 59.9485 | 2.43 | | | |
| 6 | 383.4806 | 5.21 | 1.883 | 40.8 | |
| 7 | −30.6142 | 1.24 | 1.5927 | 35.31 | |
| 8 | 30.6142 | 5.28 | 1.883 | 40.8 | |
| 9 | −205.8923 | 1.92 | | | |
| 10 | 57.3331 | 3.08 | 1.95906 | 17.47 | |
| 11 | −548.6944 | 4.53 | | | |
| 12(StB) | ∞ | 7.1 | | | |
| 13 | 20.3442 | 5.7 | 1.59282 | 68.62 | |
| 14 | −62.1811 | 1.01 | 1.53172 | 48.85 | |
| 15 | 19.7263 | 4.9315 | | | |
| 16 | −18.5053 | 0.9 | 1.71736 | 29.5 | |
| 17 | 41.418 | 2.78 | 1.6968 | 55.53 | |
| 18 | −131.9641 | 0.2 | | | |
| 19 | 26.3178 | 6.64 | 1.59282 | 68.62 | |
| 20 | −26.3178 | 1.21 | | | |
| *21 | −47.8136 | 2.75 | 1.80882 | 40.97 | |
| *22 | −29.9011 | 1.75 | | | |
| 23 | 41.9378 | 3.47 | 1.59282 | 68.62 | |
| 24 | −182.0569 | 0.1705 | | | |
| *25 | −96.5919 | 1.6 | 1.68948 | 31.02 | |
| *26 | 39.8918 | 7.5244 | | | |
| 27 | 27.6474 | 4.2917 | 1.8707 | 40.73 | U2 |
| 28 | 87.3869 | 0.0494 | | | |
| 29 | 90.3878 | 1 | 1.71299 | 53.87 | |
| 30 | 38.6759 | 10.0291 | | | |
| 31 | 62.7612 | 4.4956 | 1.90366 | 31.31 | |
| 32 | −88.0451 | 6.0319 | | | |
| 33 | −63.7918 | 1 | 1.48749 | 70.44 | |
| 34 | 67.1031 | 10.3594 | | | |
| 35 | −16.4659 | 1 | 1.59551 | 39.24 | |
| 36 | −97.1179 | 1.7501 | | | |
| 37 | −85.6212 | 7.9218 | 1.7725 | 49.62 | |
| 38 | −27.2345 | 6.0556 | | | |

TABLE 16B
Example 6

| Sn | R | D | Nd | νd | |
|---|---|---|---|---|---|
| 39 | −208.7586 | 1 | 1.80518 | 25.46 | U3 |
| 40 | 67.8061 | 0.6894 | | | |
| 41 | 83.4968 | 4.9263 | 1.92286 | 20.88 | |
| 42 | −72.707 | DD[42] | | | |
| 43 | 42.6151 | 6.5995 | 1.59282 | 68.62 | |
| 44 | −155.6009 | DD[44] | | | |
| 45 | 24.4822 | 13.1506 | 1.6968 | 55.53 | |
| 46 | −49.5252 | 0.0497 | | | |
| 47 | −47.7638 | 0.9991 | 1.84666 | 23.78 | |
| 48 | 13.9461 | 3.5 | | | |
| 49(StA) | ∞ | 8.2037 | | | |
| 50 | −14.4571 | 1 | 1.62004 | 36.26 | |
| 51 | −45.1263 | 3.3636 | | | |
| 52 | −36.8233 | 3.2533 | 1.6968 | 55.53 | |
| 53 | −22.7342 | 10.1147 | | | |
| 54 | 179.1455 | 7.9572 | 1.59282 | 68.62 | |
| 55 | −36.4769 | 0.0501 | | | |
| 56 | −4061.312 | 1.1 | 1.64769 | 33.79 | |
| 57 | 32.4885 | 0.145 | | | |
| 58 | 32.9776 | 10.698 | 1.497 | 81.61 | |
| 59 | −63.8359 | DD[59] | | | |
| 60 | 45.0207 | 5.4341 | 1.92286 | 20.88 | |
| 61 | 473.701 | 4.8264 | | | |
| 62 | ∞ | 1 | 1.5168 | 64.2 | |
| 63 | 36.0714 | DD[63] | | | |
| 64 | ∞ | 26 | 1.5168 | 64.2 | |
| 65 | ∞ | 0 | | | |

TABLE 17
Example 6

| | wide | tele |
|---|---|---|
| Zr | 1 | 1.07 |
| \|f\| | 21.87 | 23.4 |
| FNo. | 2.22 | 2.28 |
| 2ω[°] | 43.6 | 41 |
| DD[42] | 23.52 | 17.3 |
| DD[44] | 12.66 | 13.33 |
| DD[59] | 21.08 | 27.17 |
| DD[63] | 16.65 | 16.08 |

TABLE 18
Example 6

| Sn | 21 | 22 | 25 | 26 |
|---|---|---|---|---|
| KA | 1 | 1 | 1 | 1 |
| A3 | 0 | 0 | 0 | 0 |
| A4 | −2.58897E−05 | 3.83181E−05 | 7.23649E−06 | −2.73961E−05 |
| A5 | −1.29825E−05 | −2.49E−05 | 5.02391E−06 | 3.67469E−05 |
| A6 | 3.96745E−06 | 6.2636E−06 | −2.18324E−07 | −1.01919E−05 |
| A7 | −3.33032E−07 | −3.80485E−07 | −2.73555E−07 | 1.12811E−06 |
| A8 | −3.63391E−08 | −7.24063E−08 | 3.95405E−08 | −5.49779E−09 |
| A9 | 8.35078E−09 | 1.16708E−08 | 1.07272E−09 | −1.0848E−08 |
| A10 | −8.88654E−11 | 5.63034E−11 | −4.47593E−10 | 1.02468E−09 |
| A11 | −6.18245E−11 | −8.98287E−11 | 1.20862E−11 | −1.87752E−11 |
| A12 | 2.49789E−12 | 2.88559E−12 | 1.41541E−12 | −3.35991E−12 |
| A13 | 1.54328E−13 | 2.26871E−13 | −6.69876E−14 | 2.74967E−13 |
| A14 | −8.60654E−15 | −1.12789E−14 | 1.62591E−17 | −6.89344E−15 |

### Example 7

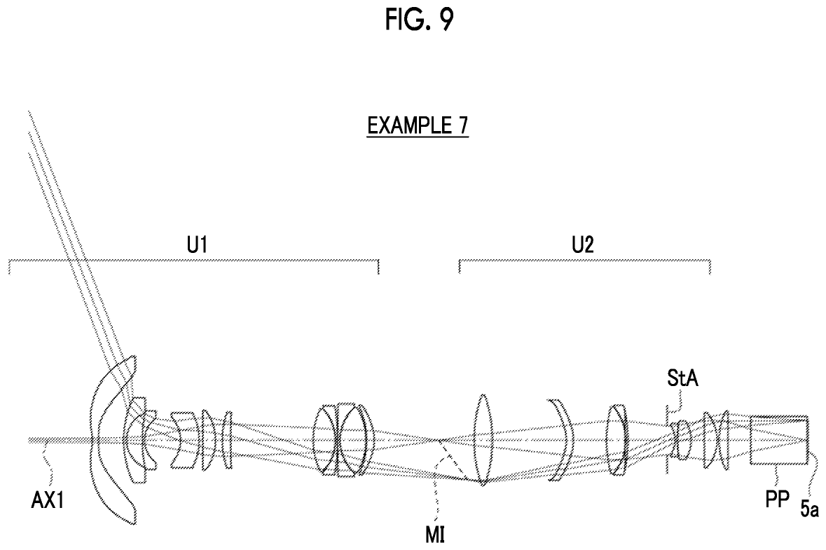

FIG. 9 shows a cross-sectional view of a configuration and luminous flux of a projection optical system of Example 7. The projection optical system of Example 7 consists of the first optical system U1 and the second optical system U2, in order from the magnification side to the reduction side as an optical system. The intermediate image MI is formed between the first optical system U1 and the second optical system U2. The first optical system U1 is interchangeable. The second optical system U2 corresponds to a relay optical system.

The first optical system U1 consists of 11 lenses. The second optical system U2 consists of four lenses, a stop StA, and four lenses, in order from the magnification side to the reduction side. The aperture diameter of the stop StA is variable.

Regarding the projection optical system of Example 7, Tables 19A and 19B show basic lens data, Table 20 shows specification, and Table 21 shows the aspherical coefficients thereof. The data of Example 7 is data which is subjected to normalization such that the absolute value of the focal length is 1.

TABLE 19A
Example 7

| Sn | R | D | Nd | νd | |
|---|---|---|---|---|---|
| *1 | −3.8571 | 0.8488 | 1.53158 | 55.08 | U1 |
| *2 | −8.2981 | 3.4286 | | | |
| 3 | 15.6205 | 0.3858 | 1.83400 | 37.16 | |
| 4 | 4.4969 | 2.1774 | | | |
| 5 | 24.2091 | 0.2829 | 1.83481 | 42.74 | |
| 6 | 4.2319 | 5.2562 | | | |
| 7 | −5.5308 | 2.5515 | 1.60311 | 60.64 | |
| 8 | −9.5531 | 0.2627 | | | |
| 9 | ∞ | 1.7413 | 1.48749 | 70.44 | |
| 10 | −7.8461 | 0.8521 | | | |
| 11 | 14.6990 | 1.1009 | 1.80518 | 25.46 | |
| 12 | 75.1118 | 11.2992 | | | |
| 13 | 11.5142 | 3.0531 | 1.58313 | 59.37 | |
| 14 | −7.0887 | 0.2701 | 1.84667 | 23.79 | |
| 15 | −35.2560 | 0.0514 | | | |
| 16 | ∞ | 0.2906 | 1.84667 | 23.79 | |
| 17 | 6.9385 | 3.5598 | 1.48749 | 70.44 | |
| 18 | −10.0146 | 0.0772 | | | |
| *19 | −11.6678 | 1.0546 | 1.51007 | 56.24 | |
| *20 | −6.1750 | 13.5729 | | | |

TABLE 19B
Example 7

| Sn | R | D | Nd | νd | |
|---|---|---|---|---|---|
| 21 | 21.7259 | 2.4898 | 1.51680 | 64.20 | U2 |
| 22 | −21.7259 | 10.1185 | | | |
| *23 | −6.0808 | 0.9774 | 1.51007 | 56.24 | |
| *24 | −6.2670 | 4.5217 | | | |
| 25 | 20.2149 | 2.6287 | 1.83481 | 42.74 | |
| 26 | −8.1700 | 0.2855 | 1.80518 | 25.46 | |
| 27 | −22.1437 | 5.3859 | | | |
| 28(StA) | ∞ | 1.0623 | | | |
| 29 | −4.3426 | 0.3087 | 1.84667 | 23.79 | |
| 30 | 16.4776 | 0.0183 | | | |
| 31 | 18.2604 | 1.8673 | 1.48749 | 70.44 | |
| 32 | −5.6543 | 1.7876 | | | |
| 33 | ∞ | 1.7619 | 1.48749 | 70.44 | |
| 34 | −6.6820 | 0.2598 | | | |
| 35 | 10.3973 | 1.2243 | 1.80518 | 25.46 | |
| 36 | ∞ | 3.1269 | | | |
| 37 | ∞ | 7.7402 | 1.51680 | 64.20 | |
| 38 | ∞ | 0.0429 | | | |

TABLE 20
Example 7

| | |
|---|---|
| \|f\| | 1.00 |
| FNo. | 1.60 |
| 2ω[°] | 141.2 |

TABLE 21
Example 7

| Sn | 1 | 2 | 19 | 20 |
|---|---|---|---|---|
| KA | −5.34602989E−01 | −2.99394974E+00 | −3.18695525E+00 | 6.40578232E−01 |
| A3 | 4.41588815E−02 | 5.37701658E−02 | 0.00000000E+00 | 0.00000000E+00 |
| A4 | −4.44842172E−04 | −2.00987958E−02 | 6.12198632E−04 | 1.63126964E−03 |
| A5 | −2.35716150E−03 | 1.25065914E−02 | −1.44395234E−04 | 5.00272556E−04 |
| A6 | 2.82162329E−04 | −5.16554571E−03 | 2.81201916E−04 | −2.19593632E−04 |
| A7 | 4.52974801E−05 | 9.72821213E−04 | −1.51554354E−04 | 1.68146572E−06 |
| A8 | −9.31391910E−06 | −3.34967083E−05 | −2.49014766E−06 | 2.28584774E−05 |
| A9 | −4.39796856E−07 | −1.44651319E−05 | 2.03060244E−05 | −6.02039291E−06 |
| A10 | 1.68438416E−07 | 1.77491054E−06 | −4.33605781E−06 | −1.74260176E−06 |
| A11 | −1.26291212E−10 | −7.30888324E−08 | −9.64760510E−07 | 7.36259753E−07 |
| A12 | −1.79919532E−09 | 1.73442401E−08 | 4.58043064E−07 | 7.22294587E−08 |
| A13 | 4.67203905E−11 | −1.48625471E−09 | 1.98820490E−09 | −4.19737968E−08 |
| A14 | 1.15610664E−11 | −3.04207065E−10 | −2.03535932E−08 | −1.34916380E−09 |
| A15 | −4.79360450E−13 | 8.88022477E−12 | 1.24116290E−09 | 1.26493150E−09 |
| A16 | −4.17565489E−14 | 1.16943716E−11 | 4.36306991E−10 | 2.14937787E−12 |
| A17 | 2.17631331E−15 | −1.78574694E−12 | −3.33503826E−11 | −1.95520674E−11 |
| A18 | 6.49952122E−17 | 1.07248437E−13 | −4.60632068E−12 | 2.85673724E−13 |
| A19 | −3.93247558E−18 | −2.59848620E−15 | 2.10731427E−13 | 1.22706849E−13 |
| A20 | 2.82311452E−21 | 1.14324796E−17 | 2.85766740E−14 | −3.06109276E−15 |

| Sn | 23 | 24 |
|---|---|---|
| KA | 1.01628889E+00 | 1.02166325E+00 |
| A3 | 0.00000000E+00 | 0.00000000E+00 |
| A4 | 1.69404176E−03 | 1.71954692E−03 |
| A5 | 9.92804167E−04 | 4.78048827E−05 |
| A6 | −4.81900268E−04 | 1.06326334E−04 |
| A7 | 2.13778804E−05 | −4.02755832E−05 |
| A8 | 5.50790405E−05 | −2.13249353E−05 |
| A9 | −1.52329771E−05 | 1.16040200E−05 |
| A10 | −2.31912652E−06 | 4.11600396E−07 |
| A11 | 1.39996322E−06 | −1.14420462E−06 |
| A12 | −7.54682221E−09 | 1.07456810E−07 |
| A13 | −6.13715799E−08 | 5.61850760E−08 |
| A14 | 4.03631136E−09 | −8.99347678E−09 |
| A15 | 1.43925402E−09 | −1.48350867E−09 |
| A16 | −1.42773952E−10 | 3.09111492E−10 |
| A17 | −1.72173569E−11 | 2.00984507E−11 |
| A18 | 2.14032043E−12 | −5.09049610E−12 |
| A19 | 8.13185348E−14 | −1.09210877E−13 |
| A20 | −1.24023377E−14 | 3.31189761E−14 |

### Example 8

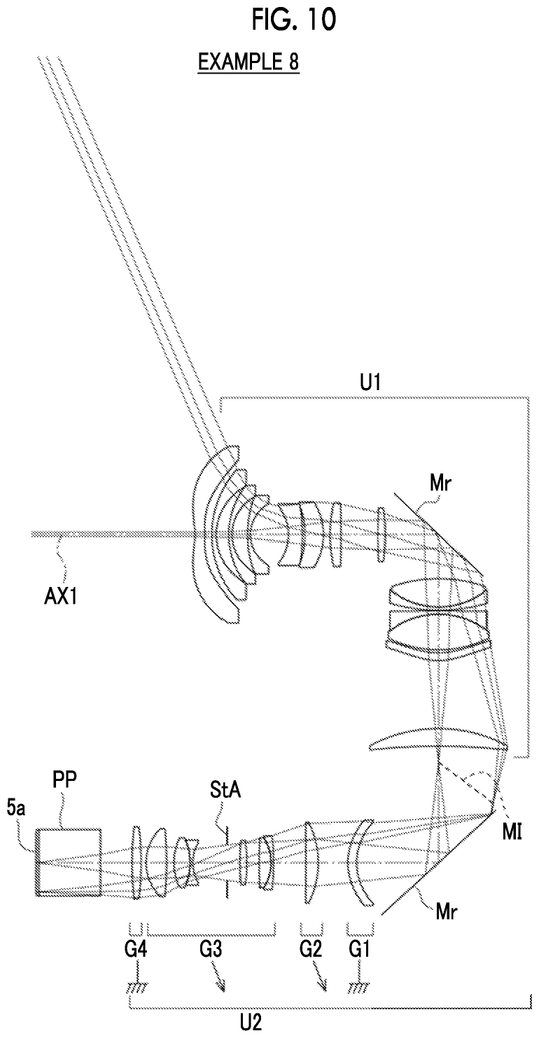

FIG. 10 shows a cross-sectional view of a configuration and luminous flux of a projection optical system of Example 8. The projection optical system of Example 8 consists of the first optical system U1 and the second optical system U2, in order from the magnification side to the reduction side. The intermediate image MI is formed between the first optical system U1 and the second optical system U2. The first optical system U1 is interchangeable. The second optical system U2 corresponds to a relay optical system.

The first optical system U1 consists of eight lenses, a mirror Mr, and six lenses, in order from the magnification side to the reduction side. The second optical system U2 consists of a mirror Mr, five lenses, a stop StA, and four lenses, in order from the magnification side to the reduction side. The aperture diameter of the stop StA is variable. The second optical system U2 is a variable magnification optical system. The second optical system U2 consists of, in order from the magnification side to the reduction side, four lens groups, that is, a first lens group G1, a second lens group G2, a third lens group G3, and a fourth lens group G4. During magnification change, the first lens group G1 and the fourth lens group G4 remain stationary with respect to the image display surface 5a, and the other two lens groups move by changing the spacing between the adjacent groups.

Regarding the projection optical system of Example 8, Tables 22A and 22B show basic lens data, Table 23 shows specifications and variable surface spacings, and Table 24 shows aspherical coefficients. In the basic lens data, the term Mr is noted in the column of the surface number of the surface corresponding to the mirror Mr. The data of Example 8 is data which is subjected to normalization such that the absolute value of the focal length is 1.

TABLE 22A
Example 8

| Sn | R | D | Nd | νd | |
|---|---|---|---|---|---|
| *1 | −4.1545 | 0.7999 | 1.53158 | 55.08 | U1 |
| *2 | −10.6553 | 0.5600 | | | |
| 3 | 9.1859 | 0.3600 | 1.77250 | 49.62 | |
| 4 | 5.0305 | 1.0131 | | | |
| 5 | 7.4758 | 0.2600 | 1.84666 | 23.78 | |
| 6 | 3.9905 | 1.2632 | | | |
| 7 | 10.3971 | 0.2200 | 1.71300 | 53.94 | |
| 8 | 3.2212 | 3.0822 | | | |
| 9 | −4.3318 | 1.0998 | 1.48749 | 70.44 | |
| 10 | −15.4301 | 0.2090 | | | |
| 11 | −7.8593 | 1.4941 | 1.51742 | 52.43 | |
| 12 | −5.6609 | 0.5386 | | | |
| 13 | 13.8954 | 0.8753 | 1.80610 | 33.27 | |
| 14 | −102.4289 | 2.9835 | | | |
| 15 | 42.9097 | 0.5993 | 1.74950 | 35.28 | |
| 16 | −18.5900 | 4.3215 | | | |
| Mr | ∞ | 3.8647 | | | |
| 17 | 10.5567 | 2.5084 | 1.49700 | 81.61 | |
| 18 | −5.7610 | 0.2820 | 1.84666 | 23.78 | |
| 19 | −13.0118 | 0.0722 | | | |
| 20 | ∞ | 0.2800 | 1.84666 | 23.78 | |
| 21 | 5.9750 | 3.1496 | 1.49700 | 81.61 | |
| 22 | −8.5088 | 0.2737 | | | |
| *23 | −4.8146 | 0.6800 | 1.51007 | 56.24 | |
| *24 | −4.2455 | 6.0218 | | | |
| 25 | 10.8969 | 1.5566 | 1.80518 | 25.46 | |
| 26 | 46.3502 | 10.3125 | | | |

TABLE 22B
Example 8

| Sn | R | D | Nd | νd | |
|---|---|---|---|---|---|
| Mr | ∞ | 6.6398 | | | U2 |
| *27 | −5.2628 | 0.6999 | 1.51007 | 56.24 | |
| *28 | −5.6967 | DD[28] | | | |
| 29 | 8.6244 | 0.9926 | 1.77250 | 49.62 | |
| 30 | 270.4297 | DD[30] | | | |
| 31 | 22.0413 | 0.2000 | 1.84666 | 23.78 | |
| 32 | 4.4142 | 0.9776 | 1.51680 | 64.20 | |
| 33 | −33.1623 | 0.9953 | | | |
| 34 | 18.0318 | 0.5380 | 1.80518 | 25.46 | |
| 35 | −36.5595 | 1.0531 | | | |
| 36(StA) | ∞ | 2.7843 | | | |
| 37 | −3.6089 | 0.2000 | 1.77250 | 49.62 | |
| 38 | 5.4293 | 1.3198 | 1.49700 | 81.61 | |
| 39 | −5.4293 | 0.5908 | | | |
| 40 | 32.4635 | 1.6690 | 1.49700 | 81.61 | |
| 41 | −4.5285 | DD[41] | | | |
| 42 | 27.8016 | 0.7396 | 1.84666 | 23.78 | |
| 43 | −27.8016 | 2.5446 | | | |
| 44 | ∞ | 5.2096 | 1.51633 | 64.14 | |
| 45 | ∞ | | | | |

TABLE 23
Example 8

| | wide | tele |
|---|---|---|
| Zr | 1.00 | 1.10 |
| \|f\| | 1.00 | 1.10 |
| FNo. | 2.40 | 2.49 |
| 2ω[°] | 137.0 | 133.2 |
| DD[28] | 2.4044 | 1.0863 |
| DD[30] | 2.5800 | 2.9950 |
| DD[41] | 0.4000 | 1.3030 |

TABLE 24
Example 8

| Sn | 1 | 2 | 23 | 24 |
|---|---|---|---|---|
| KA | −5.88485309E−01 | −2.67069029E+00 | −2.16710178E+00 | −1.59414900E+00 |
| A3 | 5.80144623E−02 | 6.20189624E−02 | 0.00000000E+00 | 0.00000000E+00 |
| A4 | −1.30172308E−02 | −2.28104869E−02 | 7.41372713E−03 | 6.49436894E−03 |
| A5 | 9.48694342E−04 | 6.47938847E−03 | −6.97790017E−03 | −4.40306962E−03 |
| A6 | 9.49648797E−04 | −4.40369971E−04 | 3.36188936E−03 | 1.01287937E−03 |
| A7 | −4.90418674E−04 | −2.67652006E−04 | 2.29165125E−04 | 1.10786608E−03 |
| A8 | 6.64281236E−05 | −4.02834763E−05 | −8.31663692E−04 | −6.70039030E−04 |
| A9 | 1.70286164E−05 | 5.45925049E−05 | 1.38746180E−04 | −6.87254981E−05 |
| A10 | −6.12543675E−06 | −5.06072745E−06 | 1.09827462E−04 | 1.30031180E−04 |
| A11 | 1.28126795E−07 | −2.75955188E−06 | −3.84449107E−05 | −1.65722432E−05 |
| A12 | 1.79154417E−07 | 4.40168978E−07 | −4.87132704E−06 | −1.01035495E−05 |
| A13 | −1.90626245E−08 | 7.33322706E−08 | 3.61614874E−06 | 2.61248502E−06 |
| A14 | −2.17463521E−09 | −1.52138561E−08 | −9.41126971E−08 | 3.14921349E−07 |
| A15 | 4.39245344E−10 | −1.14932546E−09 | −1.61630961E−07 | −1.50947685E−07 |
| A16 | 3.44909640E−12 | 2.87686403E−10 | 1.50078312E−08 | 5.46025075E−10 |
| A17 | −4.32556851E−12 | 9.84911065E−12 | 3.54266040E−09 | 4.05254384E−09 |
| A18 | 1.45963093E−13 | −2.90516270E−12 | −4.69612379E−10 | −2.46243709E−10 |
| A19 | 1.61253971E−14 | −3.76713714E−14 | −3.08935482E−11 | −4.25149287E−11 |
| A20 | −9.09523883E−16 | 1.25705812E−14 | 4.99166058E−12 | 3.98713891E−12 |

| Sn | 27 | 28 |
|---|---|---|
| KA | 0.00000000E+00 | 0.00000000E+00 |
| A3 | 0.00000000E+00 | 0.00000000E+00 |
| A4 | −4.66319123E−04 | −2.99290155E−04 |
| A5 | 1.74434014E−04 | 1.22129647E−04 |
| A6 | 9.34045911E−06 | 1.12309083E−05 |
| A7 | −5.20218194E−05 | −3.44676644E−05 |
| A8 | 8.31727162E−06 | 5.07033633E−06 |
| A9 | 1.83302991E−06 | 1.17237555E−06 |
| A10 | −4.45787223E−07 | −2.58539659E−07 |

Table 25 shows the corresponding values of Conditional Expressions (1) of Examples 1 to 8 in a case where the d line is used as a reference. Preferable ranges of the conditional expressions may be set by using the corresponding values of the examples shown in Table 25 as the upper limits or the lower limits of the conditional expressions.

TABLE 25

| | \|β\| |
|---|---|
| Example 1 | 0.926 |
| Example 2 | 0.926 |
| Example 3 | 1.052 |
| Example 4 | 1.037 |
| Example 5 | 0.541 |
| Example 6 | 1.063 |
| Example 7 | 0.507 |
| Example 8 | 0.516 |

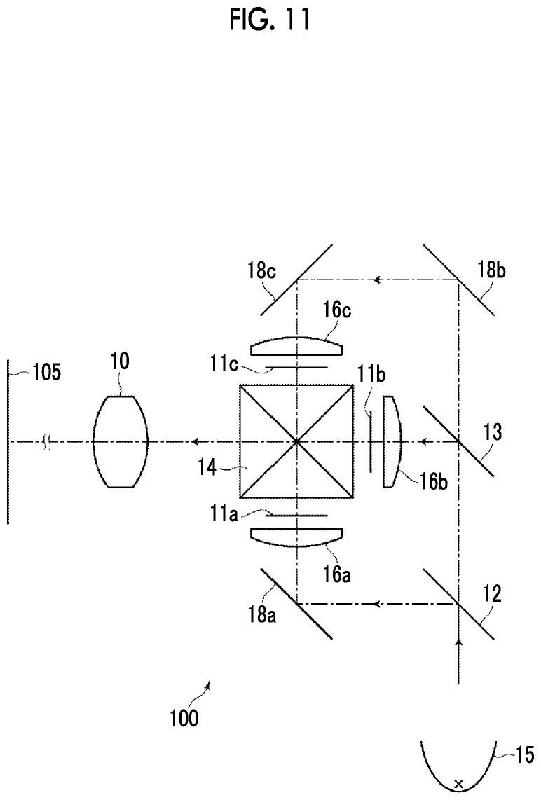

Next, a projection type display apparatus according to an embodiment of the present disclosure will be described. FIG. 11 is a schematic configuration diagram of a projection type display apparatus according to an embodiment of the present disclosure. The projection type display apparatus 100 shown in FIG. 11 has a projection optical system 10 according to an embodiment of the present disclosure, a light source 15, and transmissive display elements 11a to 11c as light valves corresponding to each color light and outputting an optical image. Further, the projection type display apparatus 100 has dichroic mirrors 12 and 13 for color separation, cross dichroic prisms 14 for color synthesis, condenser lenses 16a to 16c, and total reflection mirrors 18a to 18c for deflecting an optical path. It should be noted that, FIG. 11 schematically shows the projection optical system 10. Further, an integrator is disposed between the light source 15 and the dichroic mirror 12, but is not shown in FIG. 11.

White light originating from the light source 15 is separated into ray with three colors (green light, blue light, and red light) through the dichroic mirrors 12 and 13. Thereafter, the ray respectively pass through the condenser lenses 16a to 16c, are incident into and modulated through the transmissive display elements 11a to 11c respectively corresponding to the ray with the respective colors, are subjected to color synthesis through the cross dichroic prism 14, and are subsequently incident into the projection optical system 10. The projection optical system 10 projects an optical image, which is based on the modulated light modulated through the transmissive display elements 11a to 11c, onto a screen 105.

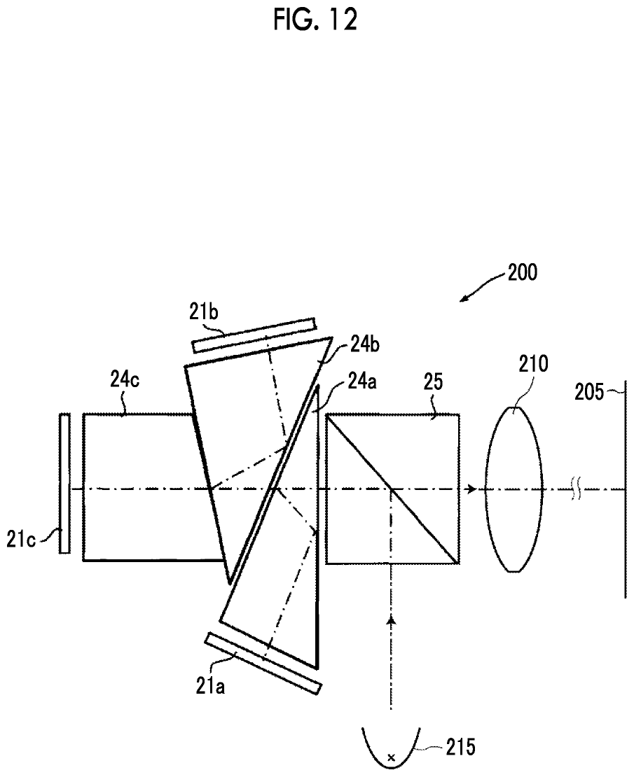

FIG. 12 is a schematic configuration diagram of a projection type display apparatus according to another embodiment of the present disclosure. The projection type display apparatus 200 shown in FIG. 12 has a projection optical system 210 according to an embodiment of the present disclosure, a light source 215, and digital micromirror device (DMD: registered trademark) elements 21a to 21c as light valves each of which outputs an optical image corresponding to each color light. Further, the projection type display apparatus 200 has total internal reflection (TIR) prisms 24a to 24c for color separation and color synthesis, and a polarized light separating prism 25 that separates illumination light and projection light. It should be noted that FIG. 12 schematically shows the projection optical system 210. Further, an integrator is disposed between the light source 215 and the polarized light separating prism 25, but is not shown in FIG. 12.

White light originating from the light source 215 is reflected on a reflective surface inside the polarized light separating prism 25, and is separated into ray with three colors (green light, blue light, and red light) through the TIR prisms 24a to 24c. The separated ray with the respective colors are respectively incident into and modulated through the corresponding DMD elements 21a to 21c, travel through the TIR prisms 24a to 24c again in a reverse direction, are subjected to color synthesis, are subsequently transmitted through the polarized light separating prism 25, and are incident into the projection optical system 210. The projection optical system 210 projects an optical image, which is based on the modulated light modulated through the DMD elements 21a to 21c, onto a screen 205.

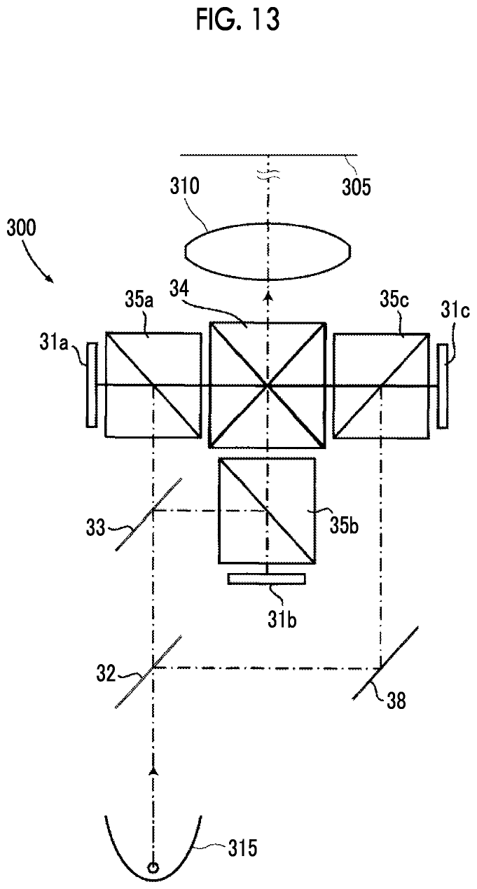

FIG. 13 is a schematic configuration diagram of a projection type display apparatus according to still another embodiment of the present disclosure. The projection type display apparatus 300 shown in FIG. 13 has a projection optical system 310 according to an embodiment of the present disclosure, a light source 315, and reflective display elements 31a to 31c as light valves corresponding to each color light and outputting an optical image. Further, the projection type display apparatus 300 has dichroic mirrors 32 and 33 for color separation, a cross dichroic prism 34 for color synthesis, a total reflection mirror 38 for optical path deflection, and polarized light separating prisms 35a to 35c. It should be noted that, FIG. 13 schematically shows the projection optical system 310. Further, an integrator is disposed between the light source 315 and the dichroic mirror 32, but is not shown in FIG. 13.

White light originating from the light source 315 is separated into ray with three colors (green light, blue light, and red light) through the dichroic mirrors 32 and 33. The separated ray with the respective colors respectively pass through the polarized light separating prisms 35a to 35c, are incident into and modulated through the reflective display elements 31a to 31c respectively corresponding to the ray with the respective colors, are subjected to color synthesis through the cross dichroic prism 34, and are subsequently incident into the projection optical system 310. The projection optical system 310 projects an optical image, which is based on the modulated light modulated through the reflective display elements 31a to 31c, onto a screen 305.

The technique of the present disclosure has been hitherto described through embodiments and examples, but the technique of the present disclosure is not limited to the above-mentioned embodiments and examples, and may be modified into various forms without departing from the spirit of the technique of the present disclosure. For example, the number of lenses included in each optical system, the number of lens groups included in the variable magnification optical system, and the number of lenses included in each lens group may be different from the numbers in the above-mentioned examples. Further, values such as the curvature radius, the surface spacing, the refractive index, the Abbe number, and the aspherical coefficient of each lens are not limited to the values shown in the examples, and different values may be used therefor.

Further, the projection type display apparatus according to the technique of the present disclosure is not limited to the above-mentioned configuration, and may be modified into various forms such as the optical member used for ray separation or ray synthesis and the light valve. The light valve is not limited to a form in which light from a light source is spatially modulated through an image display element and is output as an optical image based on image data, but may be a form in which light itself output from the self-light-emitting image display element is output as an optical image based on the image data. Examples of the self-light-emitting image display element include an image display element in which light emitting elements such as light emitting diodes (LED) or organic light emitting diodes (OLED) are two-dimensionally arranged.

Regarding the above-mentioned embodiments and examples, the following Supplementary Notes will be further disclosed.

Supplementary Note 1

A projection optical system that projects an image, which is displayed on an image display surface on a reduction side, to a magnification side,
in which at least one intermediate image is formed inside the projection optical system, and
the projection optical system comprises a first stop, of which an aperture diameter is variable, at a position closer to the reduction side than the intermediate image closest to the reduction side.

Supplementary Note 2

The projection optical system according to Supplementary Note 1, further comprising an interchangeable optical system at a position closer to the magnification side than the first stop.

Supplementary Note 3

The projection optical system according to Supplementary Note 2,
in which the interchangeable optical system includes a second stop of which an aperture diameter is variable, and
an F number of the projection optical system is determined by the first stop.

Supplementary Note 4

The projection optical system according to Supplementary Note 2 or 3, further comprising a group that moves by changing a spacing between adjacent groups during magnification change, in a part different from the interchangeable optical system.

Supplementary Note 5

The projection optical system according to any one of Supplementary Notes 1 to 4, in which assuming that
a combined lateral magnification of lenses ranging from a lens closest to the magnification side among lenses, of which magnification side lens surfaces are located closer to the reduction side than the intermediate image closest to the reduction side, to a lens closest to the reduction side in the projection optical system is β,
   where β is a value in a case where the magnification side is an object side and the reduction side is an image side, and
   β is a value at a wide angle end in a case where the projection optical system includes a variable magnification optical system,
Conditional Expression (1) is satisfied, which is represented by
0.25<|β|<2 (1).

Supplementary Note 6

The projection optical system according to Supplementary Note 5, in which Conditional Expression (1-1) is satisfied, which is represented by
0.4<|β|<1.5 (1-1).

Supplementary Note 7

The projection optical system according to any one of Supplementary Notes 1 to 6, in which stop blades included in the first stop are made of metal.

Supplementary Note 8

The projection optical system according to any one of Supplementary Notes 1 to 6, in which stop blades included in the first stop are made of heat resistant resin.

Supplementary Note 9

A projection type display apparatus comprising:
a light valve that outputs an image; and
the projection optical system according to any one of Supplementary Notes 1 to 8.

What is claimed is:

1. A projection optical system that projects an image, which is displayed on an image display surface on a reduction side, to a magnification side,
wherein at least one intermediate image is formed inside the projection optical system, and
the projection optical system comprises a first stop, of which an aperture diameter is variable, at a position closer to the reduction side than the intermediate image closest to the reduction side.

2. The projection optical system according to claim 1, further comprising an interchangeable optical system at a position closer to the magnification side than the first stop.

3. The projection optical system according to claim 2,
wherein the interchangeable optical system includes a second stop of which an aperture diameter is variable, and
an F number of the projection optical system is determined by the first stop.

4. The projection optical system according to claim 2, further comprising a group that moves by changing a spacing between adjacent groups during magnification change, in a part different from the interchangeable optical system.

5. The projection optical system according to claim 1, wherein assuming that
a combined lateral magnification of lenses ranging from a lens closest to the magnification side among lenses, of which magnification side lens surfaces are located closer to the reduction side than the intermediate image closest to the reduction side, to a lens closest to the reduction side in the projection optical system is β,
where β is a value in a case where the magnification side is an object side and the reduction side is an image side, and
β is a value at a wide angle end in a case where the projection optical system includes a variable magnification optical system,
Conditional Expression (1) is satisfied, which is represented by
0.25<|β|<2 (1).

6. The projection optical system according to claim 5, wherein Conditional Expression (1-1) is satisfied, which is represented by
0.4<|β|<1.5 (1-1).

7. The projection optical system according to claim 1, wherein stop blades included in the first stop are made of metal.

8. The projection optical system according to claim 1, wherein stop blades included in the first stop are made of heat resistant resin.

9. A projection type display apparatus comprising:
a light valve that outputs the image; and
the projection optical system according to claim 1.
